(19) United States
(12) Patent Application Publication
(10) Pub. No.: US 2018/0114154 A1
(43) Pub. Date: Apr. 26, 2018

(54) O2O Business Model For Marketing Services

(71) Applicant: SEOK HEE BAE, San Jose, CA (US)

(72) Inventor: SEOK HEE BAE, San Jose, CA (US)

(21) Appl. No.: 15/784,522

(22) Filed: Oct. 16, 2017

Related U.S. Application Data
(60) Provisional application No. 62/410,607, filed on Oct. 20, 2016.

(51) Int. Cl. G06Q 10/06; G06Q 30/02

(52) U.S. Cl. CPC G06Q 10/067; G06Q 30/0248; G06Q 30/0283; G06Q 30/0258

(57) ABSTRACT

An O2O business model is provided, comprising steps for: a client's selecting a single service, selecting first layers of corresponding layered service modules, and selecting providers according to the client's selecting of the single service and the first layers; the server's providing information and a listed price of each of the providers in response to the client's selecting; the client's communicating via a limited messenger with the preferred group of service providers, and selecting second layers of detailed service module of the corresponding layered service modules of the preferred or selected group of service providers in order to redefine the service; the server's providing a adjusted price of each provider in response to the client's selecting the second layers of detailed service module; the client and each of the providers's discussing and agreeing on parameters (a variety of variables for the service task) for further prices.

### RELATED APPLICATION

This application is a Non-provisional application of Provisional Application Ser. No. 62/410,607 for “O2O Business Model For Marketing Services” filed on Oct. 20, 2016.

### BACKGROUND OF THE INVENTION

The present invention relates to an O2O business model for marketing services.

A need for an O2O business model for marketing services has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide an O2O business model for marketing services.

An aspect of the invention provides an O2O business model system for marketing services between a plurality of providers and a client in a computer network having a server and a plurality of terminals.

The O2O business model comprises steps for:

each of the plurality of providers's registering as a member at the server and inputting a plurality of prices for layered service modules categorized according to kinds of services to provide and a plurality of coefficient values for calculating prices;

the client's selecting a single service, selecting first layers of corresponding layered service modules, and selecting a group of providers out of the plurality of providers suggested according to the client's selecting of the single service and the first layers;

the server's providing information and a listed price of each of the selected group of providers in response to the client's selecting;

the client's communicating via a limited messenger with the preferred or selected group of service providers, which are chosen based on the listed price, and selecting second layers of detailed service module of the corresponding layered service modules that are more detailed than the first layers of the preferred or selected group of service providers in order to redefine the service;

the server's providing a adjusted price of each of the selected group of providers in response to the client's selecting the second layers of detailed service module;

the client and each of the selected group of providers's discussing and agreeing on parameters (a variety of variables for the service task) including sentences and memos to be included in the estimate and invoice for determining, upon agreement between the client and each of the selected group of providers, which are chosen based on the adjusted price, a selection of preset detailed coefficient values that the server uses in providing a quoted price of each of the selected group of providers to the client, and the preset detailed coefficient values are selected for providing the quoted price to the client and the selected group of providers, and the server produces the estimate using newly written sentences and memos or the selected sentences and memos that inputted and registered in the server in advance;

the client's comparing and choosing service from the plurality of providers based on the listed price, the adjusted price, and the quoted price along with a company profile, a grading rate assigned by an AI system, words and sentences presented by the server based on previous client's evaluations of each of the providers so that the client refers to the presented words and sentences, degree of kindness of staffs, degree of satisfaction of customized service, technology level, further sentences and memos for details of the service to be included in the estimate, difference in prices, and deciding whether all information used to obtain the listed price, the adjusted price, and the quoted price are reasonable; and

the server's generating an estimate, an invoice, and a contract, wherein the estimate is generated on completion of memos related to the service modules that the client and the service provider selected together and the selection of detailed service and values of corresponding coefficients.

The O2O business model system may further comprise a step in which each of the service providers inputs module prices for three layers of detailed service module of the corresponding layered service modules in order to redefine the service in advance, so that the client selects some of the first, second, and third layers of detailed service modules in a desired step for the listed price, the adjusted price, or the quoted price.

The selecting the group of providers in order to calculating the adjusted price may be based on the listed price, along with a company profile, a grading rate assigned by an AI system, and difference in prices that the client reviews, and then the client selects the second layers of service modules that are in more detail than the first layers of service modules.

The layered service module may comprise a graphic module providing with service-related pictures for helping the client in selecting one or more providers.

The limited messenger function may be provided, in which the client is enabled to exchange text messages, images, voice communication with the selected group of providers in the wish list while the corresponding selected providers are in the wish list.

The said step for the client and each of the selected group of providers's discussing, determining, and inputting further comprises a step for the client or one of the selected group of providers's visiting a venue related to the selected service and selecting detailed modules or coefficient values, and the visiting of the venue is arranged through the enabled exchanging of text messages, voice communication between the client and the one of the selected group of providers.

The limited messenger function between the provider and the client may be deactivated when the provider is removed from the wish list or an event between the provider and the client is over.

The O2O business model system may further comprise a step for creating one or more sub-modules by the group of providers upon the system's approving a corresponding request for the one or more sub-modules by the group of providers. And the first layers or the second layers detailed service module may comprise sub-layers for further details, which are added of defined by the client, the provider, or the client and provider for defining details of the service.

The step for the server's providing of the adjusted price may comprise a step for analyzing conditions or big data including season, peak time, schedule, time of the day, price of material, and weather.

The O2O business model system may further comprise steps for: the system's generating and providing an estimate based on the quoted price to the client logged in the server; the server's generating and providing the invoice and the contract automatically when the client approves the estimate; and a step for automatically generating a contract between the client and a website for the O2O business model system, wherein contents of the contract are determined by the AI system according to the service types.

In the step for the system's generating and providing an estimate, at least a portion of words, clauses, sentences, and expressions for a memo column of the estimate may be selected from a database created and maintained by the one of the selected group of providers and added to a predetermined default estimate. Each of the selected group of providers may be given with samples of the words, clauses, sentences, and expressions to choose from by the corresponding provider from its own DB, and the samples of the words, clauses, sentences, and expressions may be customized to each of the selected group of providers and stored in a database for each of the selected group of providers.

The O2O business model system may further comprise a step for summarizing and showing the listed price, the adjusted price, and the quoted price along with the plurality of coefficient values and the detailed coefficient values of the one of the selected group of providers.

The O2O business model system may further comprise a step for using the AI system and determining the grading rate for one of the plurality of providers using a company profile.

The company profile may comprise size of company, store interior design, number of employee, number of years with the O2O business model system, number of projects, year of establishment, total sales, insurance, certificate, license, client reviews rate, number of reviewers, response time upon clients' request, response rate, activity rate on the O2O business model system, provider grade by O2O business model system, number of dissatisfaction received from clients, and number of breach of contract.

In the above embodiment of the invention, the O2O business model system may further comprise a step for the preferred or selected group of service providers and selecting third layers of detailed service module of the corresponding layered service modules that are more detailed than the first and second layers of the preferred or selected group of service providers in order to redefine the service, and the three layers of detailed service module includes items comprising selecting service area, service work, service amount, service size, service kind, and man-hour, enabling the service providers to quantify the items and input or adjust the prices at a specific step.

Another aspect of the invention provides a price comparison service method for O2O business model between a plurality of providers and a client in a computer network having a server and a plurality of terminals.

The method comprises steps for:

inputting a plurality of prices for layered service modules associated with corresponding images and texts related to the service by each of the plurality of providers;

selecting first layers of a corresponding layered service modules by the client;

once the client selects preferred service providers and a first layer of service modules, the server's providing a listed price by summarizing module prices that each of a predetermined number of providers provides in advance, that the server prepared in advance, so that the client compares the listed price;

selecting second layers of detailed service module of the corresponding layered service modules that are more detailed than the first layers by the client;

if the client communicates with the preferred service provider through a messenger and selects the second layers of service modules, the server's providing a adjusted price for each of the predetermined number of providers by summarizing modules and prices that the server prepared in advance;

the client and each of the one or more selected providers's discussing and agreeing on parameters (a variety of variables for the service task) for determining use of preset detailed coefficient values that the server uses to calculate, after the client meets the predetermined number of providers in a venue for providing the service and each of the predetermined number of providers selects the kinds of final work and memos in the database, so as to provide a quoted price of each of the predetermined number of providers to the client by adjusting the preset detailed coefficient values and making a decision; and

summarizing and showing a combination of the listed price, the adjusted price, and the quoted price along with the plurality of coefficient values and the detailed coefficient values of the predetermined number of providers in terms of table, graph, or chart by the server.

Still another aspect of the invention provides a company-grading method for O2O business model between a plurality of providers and a client in a computer network having a server and a plurality of terminals.

The method comprising a step for determining the grading rate for one of the plurality of providers using a company information using an AI system, wherein the company profile comprises size of company, store interior design, number of employee, number of years with the O2O business model system, number of projects, year of establishment, the total sales, insurance, certificate, license, client reviews rate, number of reviewers, response time upon client's requests, response rate, activity rate on the O2O business model system, provider grade by O2O business model system, number of dissatisfaction received from clients, and number of breach of contract.

And the AI system analyzes and processes technical sentence and memo inputted to a provider's database for the unique estimate and invoice by the providers with a machine-learning technique, so as to calculate point values for company-grading. The AI system measures frequency of using of technical sentences and gives points according to suitability and the frequency of the technical sentences, and the provider stores a plurality of unique technical sentences and expressions in the provider's database, so as to be used by the AI system in generating the grade.

The AI system provides a plurality of environment coefficients for the adjusted price with the analyzing conditions or big data including various external factors obtained from Internet comprising season, peak time, schedule, time of the day, price of material, and weather.

The AI system uses different applications for different variables, elements, and contract terms, based on the service types, and the contract terms are selected so as to fit to corresponding service types and to be agreeable to the client and the provider.

The AI system may automatically generate a warning message to the O2O business model system, and the O2O business model system audits the provider to determine fraudulent activity if the provider's total sales increases unrealistically from the previous year compared to the average growth rate of the local market.

The AI system may generate the grade of the providers every quarter through an algorithm along with the response time data collected through the server. The server may collect data from the communication exchanged between providers and their potential clients, and this communication response time may measure the time interval that occurs between the initial request sent by clients and the first response sent by the provider. The AI system may use one of the data for generating the provider's grade generating that the provider stores the unique technical sentence and memo to a provider's database for the estimate and invoice quality. Each of the service providers may store proper technical sentences and memos related to the service. The AI system may learns sentences related to the service and grades the level of sentences that the service provider inputs, and measure quantity of technical sentences and memos and frequency of using the technical sentences and memos in the estimate that the service provider submits to the client.

The advantages of the present invention are: (1) The O2O business model for marketing services according to the invention enables to connect the client and the providers efficiently; and (2) The O2O business model for marketing services provides means for the client to compare the service providers and come up with a service price estimates and contracts.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1-1 shows modules for generating the price according to an embodiment of the invention;

FIG. 1-2 shows a Kitchen Remodeling photo sample for 1^{st} List Price according to an embodiment of the invention;

FIG. 2 shows Modules for Providers (example; painting service) according to an embodiment of the invention;

FIG. 3 shows modules for clients in the case of paining according to an embodiment of the invention;

FIG. 4-1 shows augmented modules system for an exemplary case of water heater according to an embodiment of the invention;

FIG. 4-2 shows augmented modules system with additional modules according to an embodiment of the invention;

FIG. 4-3 shows augmented modules system with module's tags according to an embodiment of the invention;

FIG. 5 shown a chat window for client with provider according to an embodiment of the invention;

FIG. 6 shows Business flow for Client and Provider according to an embodiment of the invention;

FIG. 7 shows Variables that affect the 2^{nd} adjusted price according to an embodiment of the invention;

FIG. 8 shows Generate 3^{rd} quoted price and estimate according to an embodiment of the invention;

FIG. 9 shows 3-Step Price Rule Explanation as an exemplary case of painting service according to an embodiment of the invention;

FIG. 10 shows a sample version of estimate according to an embodiment of the invention;

FIG. 11 shows a sample version of invoice/engagement terms according to an embodiment of the invention;

FIG. 12 shows a weight value that is used to determine provider's grade according to an embodiment of the invention;

FIG. 13 shows a sample of painting service DB's field for project description according to an embodiment of the invention;

FIG. 14 shows a sample of painting service DB's field for provider's memo according to an embodiment of the invention;

FIG. 15 show a data flow of description and memo with provider DB; and

FIG. 16 shows how an AI system decides the point with AAA's response time according to an embodiment of the invention.

### INTRODUCTION

### Problems of the Current Market

1) Due to a lack of specialized knowledge, clients experience difficulties in requesting the complex projects/order through current online marketplaces.
2) Customers experience difficulties making a decision through phone consultation as each company has a different philosophy and approach to solve problems.
3) Customers cannot easily comprehend as each project requires different elements to consider.
4) Customers experience difficulties making a decision as the companies don't provide estimate for the small projects.
5) Customers experience difficulties making a decision as the price range gap of a project of certain areas are too broad.
6) It is difficult to compare the price even if there is a price gap as the service work doesn't have quantification.
7) It is difficult to run a background check on the company whose estimates are inexpensive.
8) It is difficult to identify an unethical company that doesn't provide an actual service once it receives a security deposit.
9) It is difficult to compare the companies as their estimates are very subjective and not standardized.
10) Roughly written estimates and invoices may not guarantee the good result of the service work.
11) It is inconvenient to arrange meetings with various types of people for consultation.
12) It is unsafe to allow a small local company that only shares its phone number to visit a house for consultation.
13) It is unreliable when the company doesn't investigate the house seriously and provide unprofessional recommendations during a home visit.
14) It is unreliable when the company gives the estimate roughly and inaccurately.
15) There is no tool that investigates the basic parameter that generates price of each company objectively.
16) Customer gives an order uncomfortably. (Despite of non-refundable contract)
17) It is inconvenient when neglect of duty, labor strike, or delay happens during the project.
18) It is difficult to get a warranty (After-sales Service) when the customer makes a contract with a company directly with a simple agreement.
19) It is difficult to identify the companies that have positive price-quality correlation.
20) It is inconvenient when the service price is hourly charged as a company can extend the work hours intentionally.
21) It is difficult to identify a licensed and insured company without professional knowledge
22) Company may overcharge by executing unnecessary replacement of a component.
23) With a poorly written contract, it is difficult to mediate when the project does not completely finish.
24) Customer may feel frustrated when he has a conflict with a contractor.
25) Customer can't easily raise his voice because of the contractor's technical knowledge.
26) Customer may regret his choice by choosing a disqualified contractor.
27) It is difficult to compare price, professional knowledge, and quality of service when it comes to a local store.
28) Customer can easily get disappointed when he receives a service or home visit service.

### TO MAKE A BETTER SERVICE EXPERIENCE

### Customers' Perspective:

1) They should gain access price of the interested service and the price fluctuation by the segmentation of service module.
2) They should gain access to the rates of the company's grade and the background information behind the rate.
3) They should be able to see customer reviews and write reviews after they receive a service.
4) They should be able to compare the price of the services provided by each company easily.
5) They should be able to figure out the coefficient of the selected modules of each company for the price comparison.
6) They should be able to communicate with the interested companies efficiently through app.
7) They should be able to get standardized and formatted invoices and contract.
8) There should be a system that and manages the companies' service work and take the responsibility for the duties of the company.
9) There should be a system that manages companies to perform a responsible after-sales service for a certain amount of time.
10) They should feel that they receive the great service with reasonable price.

### Companies' Perspective:

1) It should not be a business model that companies pay the advertisement expense.
2) They should be able to set up their service price and coefficient anytime and anywhere.
3) They should be able to use a platform to post their detailed profile, pictures, and background information and share with the customers.
4) They should be able to enter respective coefficient.
5) They should be able to understand the customers' request which is filtered by the module by its category and answer their questions in a timely manner.
6) They should be able to communicate with the prospective clients efficiently through app.
7) They should be able to walk through the module and show the revised price upon each “click” with a tablet PC to their clients at the consultation meeting.
8) There should be a system that populates both standardized forms with customized sentence such as estimates, invoices, and terms of condition with one click.
9) They should be able to comment below to the customer review that rate is low than the expected one.
10) There should be a company grade system that increases the rate of the companies that have provided great service for a long term period.

### Definition

“Cliencom”=a provisional company name of O2O web and app service provider,

Store/shop=local company for the service,

Company=general word of the company (both registered and unregistered company),

Provider=registered company with membership in “Cliencom”,

Customer=general word of the customer,

Client=a customer became a client in “Cliencom”

### DESCRIPTION OF THE INVENTION

An O2O business model that provides price comparison and payment system is provided.

This invention has been produced to provide a platform of standardized modules for the various kinds of services by the various service companies (company, store, shop). The platform furnishes the information of the company's price comparison and company grade rating system for client selects the right company efficiently. Also, O2O business model helps to establish a client's satisfying contract with the company using its automatically generating estimates, invoices and contracts for the service price is higher than a fixed price or a kind of the service that has complicated modules.

In other words, the platform furnishes the companies' service price with the 3 stage as the standardized modules of the various services for the price comparison and company grade rating system so that client could compare the price against quality which is expected. Also, O2O business model make to increase the client's satisfaction of the contract with the company using the “agreement” icon of the detailed standard terms of the contracts to prevent any disputes with company.

1^{st} list price filtering stage, the server posts the available providers within the covered geography, their prices, profile, performance level, history, license and insurance availability, client rating etc once the module and service date are selected.

2^{nd} adjusted price filtering stage, a client can communicate with up to a plurality of providers from the list by text, phone, and sending pictures. In this stage, the app generates revised prices based on the detailed module.

3^{rd} quoted price stage, a client can schedule a meeting with the selected providers and get the estimates.

If a service price is higher than a fixed price, a client can review the estimate/invoice prior to the contracts; the “Cliencom” server presents the client and provider to click “agreement” icon or “sign” at the estimate/invoice to prevent disputes between client and provider. The “Cliencom” server also generates electronic voucher for clients/providers to the service to be used at the store. (The electronic voucher also applies to the indoor service on client's venue.)

The “Cliencom” boosts the client's satisfaction as well as the quality of service as it doesn't transfer the paid fund to the provider until the project is completed.

### THE POINTS OF THE INVENTION

### Invention Point 1

Once the companies become the providers if they register to server with their profile and input the price and coefficient to the modules in the service, industry, and project types for the turn-key based price and then, client could view the companies' profile and the 1st listed prices when client selects the modules and selects the providers.

### Invention Point 2

When the client store the selected providers to the wish list, client can communicate with provider by text, phone, sending pictures on the app. (Once the project is completed, the messenger service will be automatically terminated.)

### Invention Point 3

The server automatically generates 2^{nd} adjusted price once the client or provider selects the detailed and specific module related to a service at the store or outsourcing service works.

### Invention Point 4

The server automatically generates the quoted price once the client and provider enter the coefficient value after they choose the service range during consultation meeting.

### Invention Point 5

The server automatically generates 3^{rd} quoted price (or the estimate for the service is higher than a fixed price) once the providers input the revised coefficient value based on addition works during the client venue. (or client visits provider's store.)

### Invention Point 6

When it is necessary to add new module due to the lack of existing categorized modules, any provider could suggest a module sentence on tag, additional module and sub-module blank space. Once sever administrator approved it, the system will automatically expand new module or new sub-modules on the module database. (Augmented modules system)

### Invention Point 7

AI system analyzes big-data which contains the seasonal, peak and off season, daily time (weekdays, weekends, night-time), material price, weather condition, and providers coefficient together with the list price and generates the adjusted price with narrow down multi-layer method.

### Invention Point 8

The server automatically generates 3^{rd} quoted price (or the estimate for the service is higher than a fixed price) once the providers input the weight value based on addition works during the client venue. (or client visits provider's store.)

The AI system generates the customized estimate based on the server detailed modules selected by client/provider and then, the server makes a process for client/provider to agreements in advance.

### Invention Point 9 (for the Memo Description)

The server populates the memo sentences automatically when provider clicks the description list in the data base that contains the memo description for the estimate. The quoted price is revised if the provider clicks the memo sentence in his DB that shows the historical sentence and coefficient. Once the agreement is made between the client/provider, the final estimates will be uploaded to the server and it will be sent to client/provider. (Also, there is a function of provider inputs his memo and coefficient value in manually.)

Invention Point 10 (The function to create the customized estimates)

The providers could access own DB for own customized estimates description apart from the standardized description DB, so that the each provider has different memo style on the estimates' standard format.

Invention Point 11 (The function to create the customized invoice/contracts)

The server generates the customized invoice/terms of agreement with proper sentence automatically for client/provider to make the contract go smoothly after the client approves the customized estimate.

### Invention Point 12

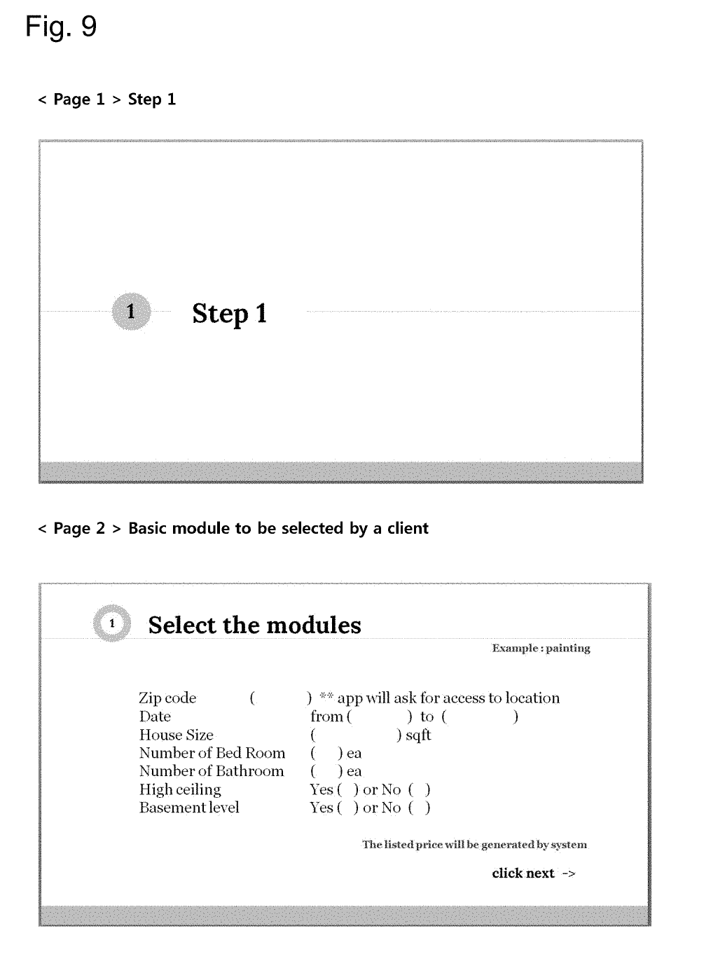

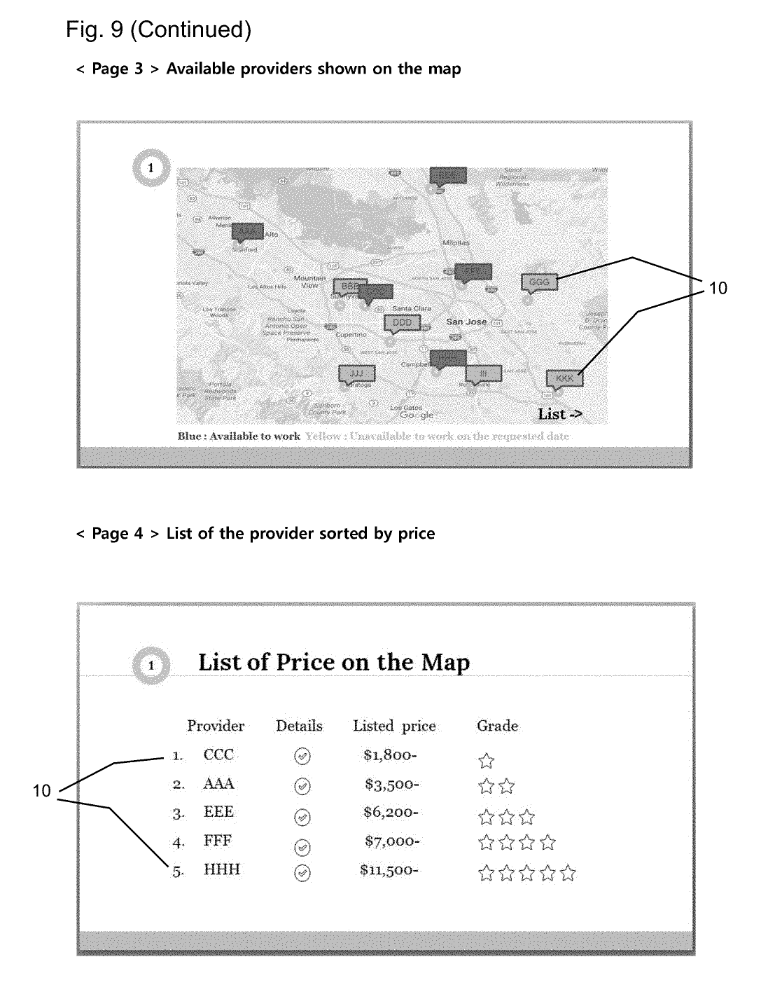

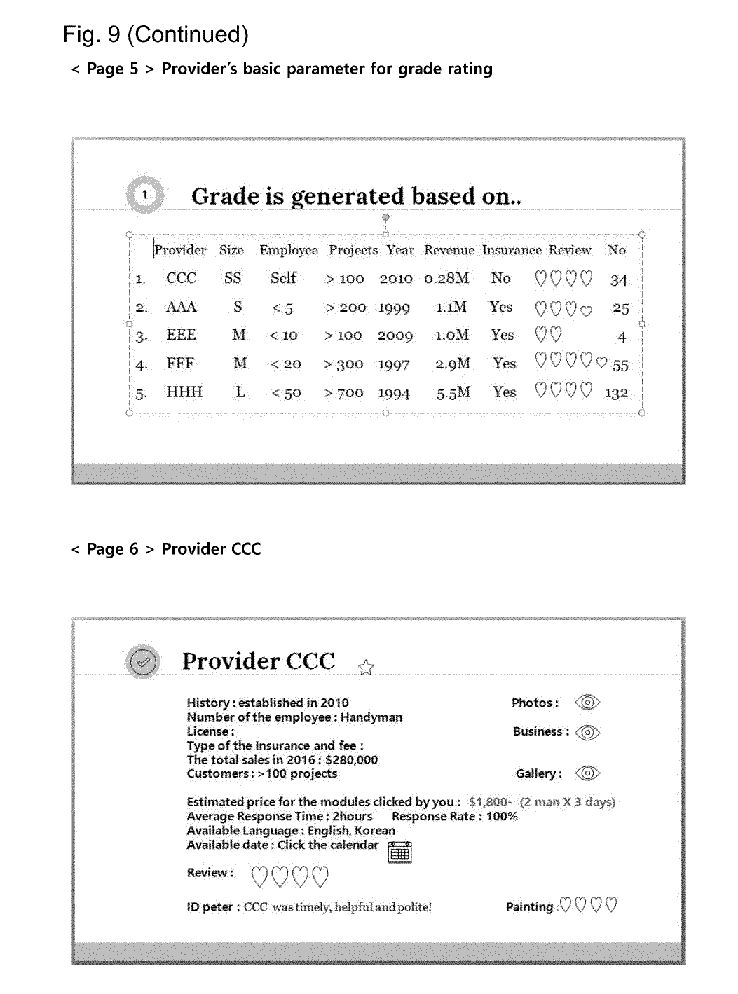

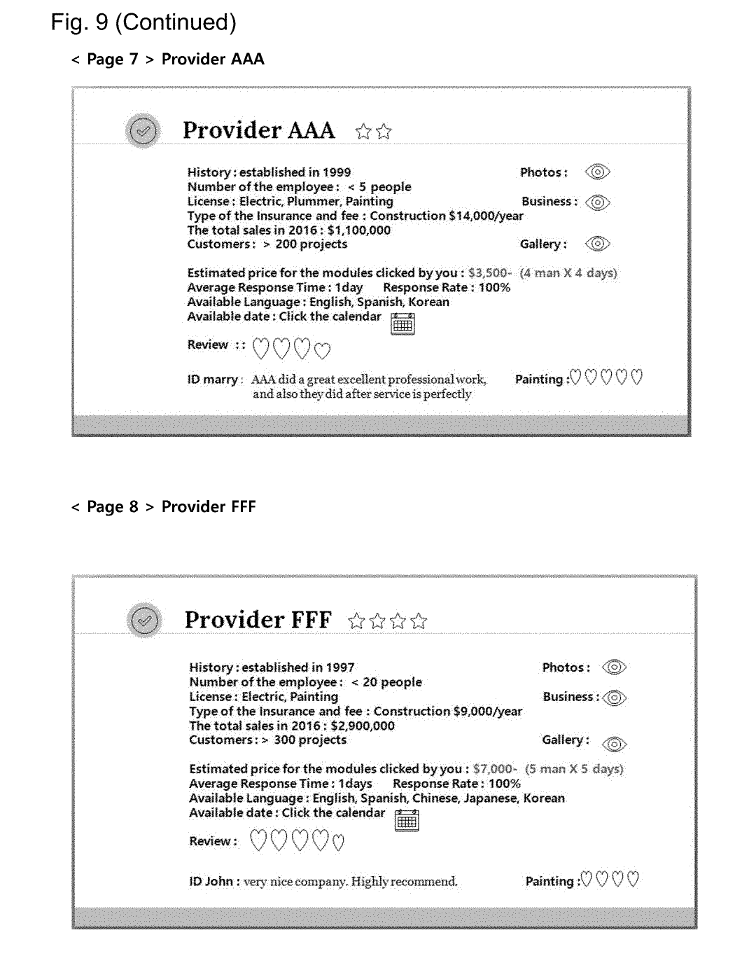

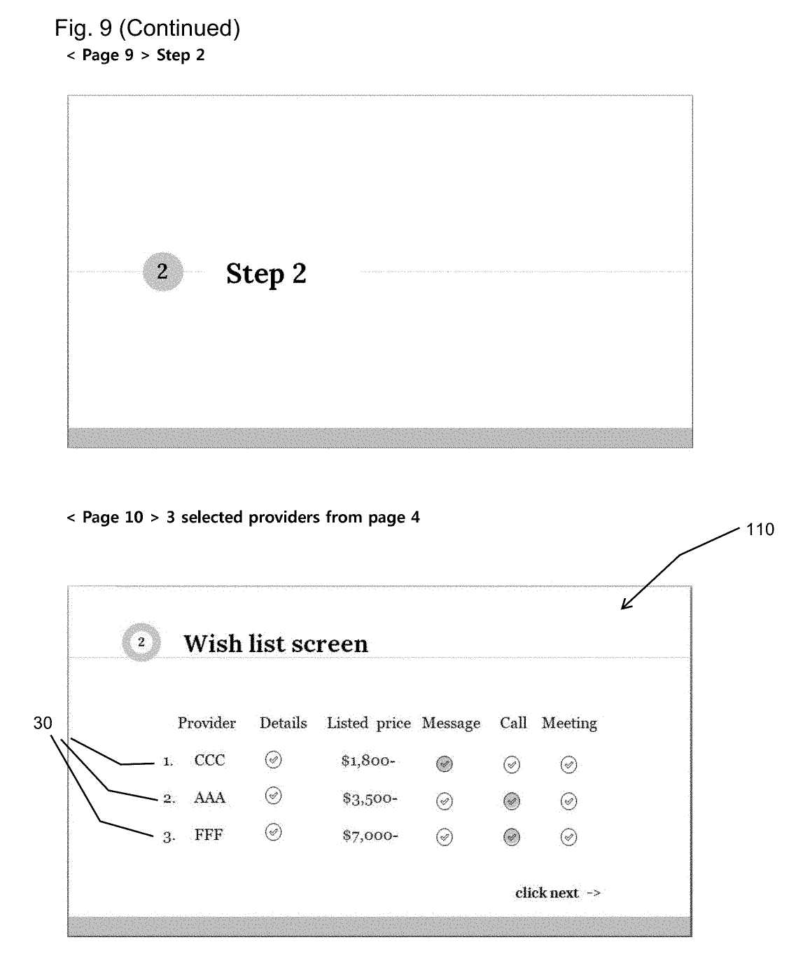

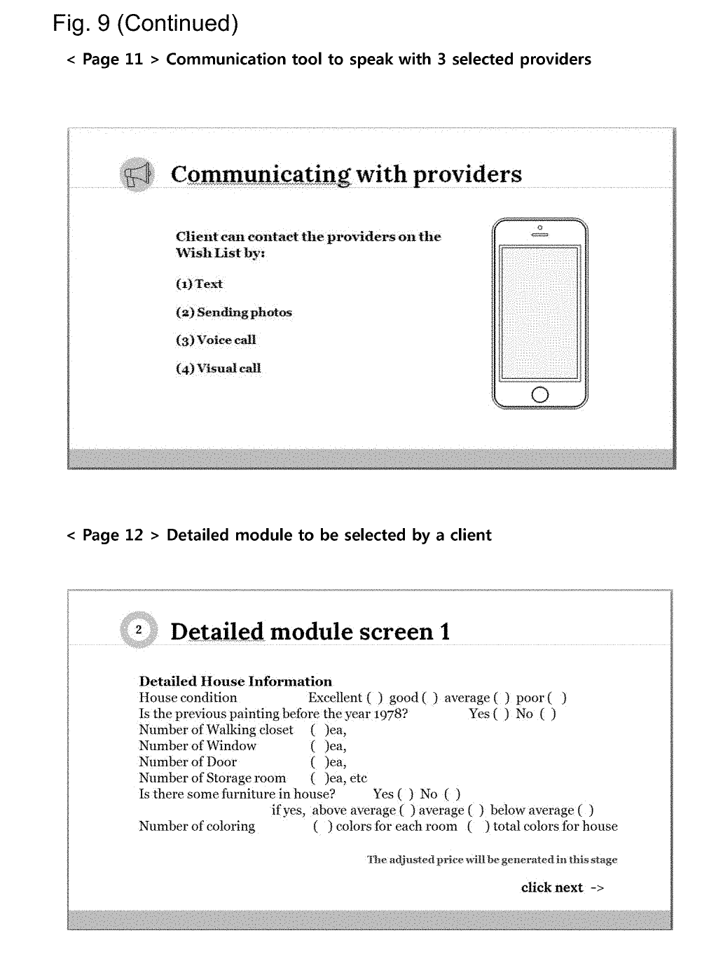

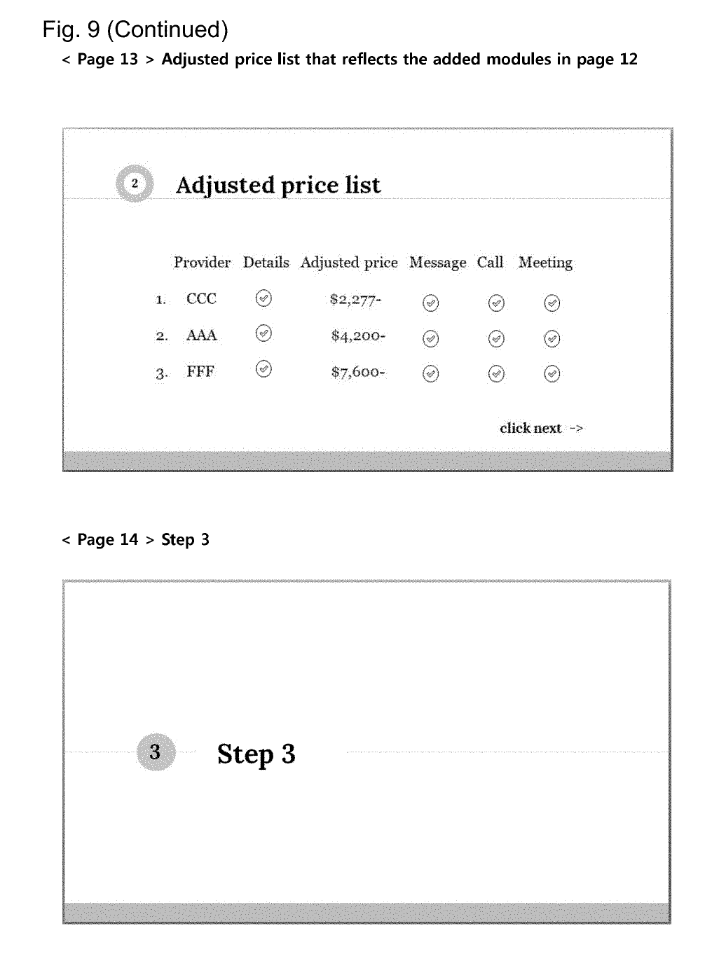

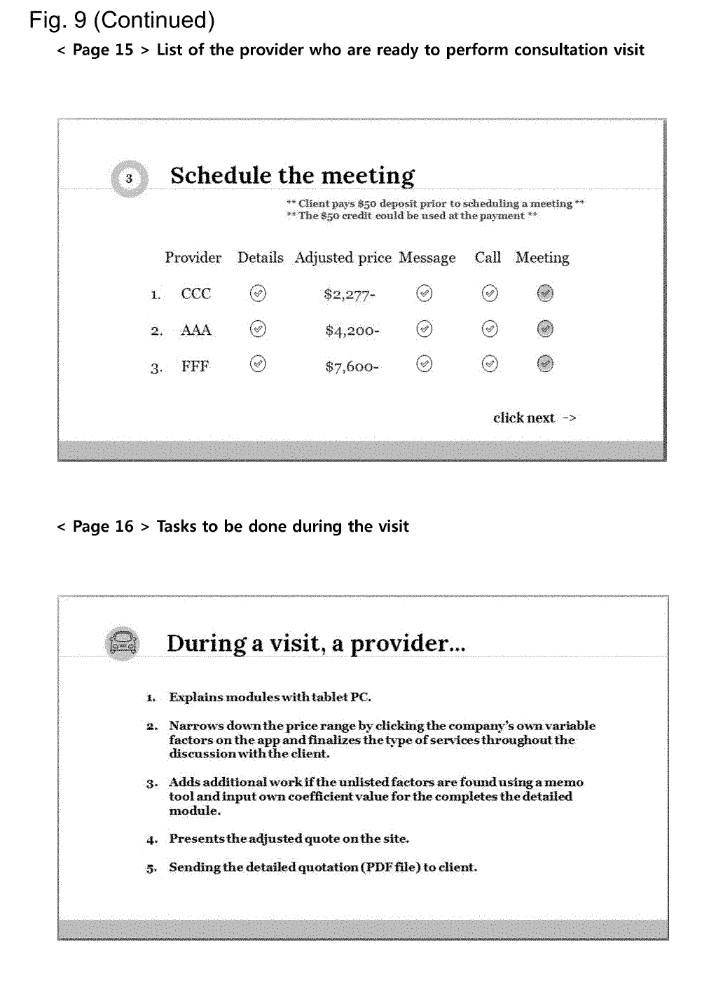

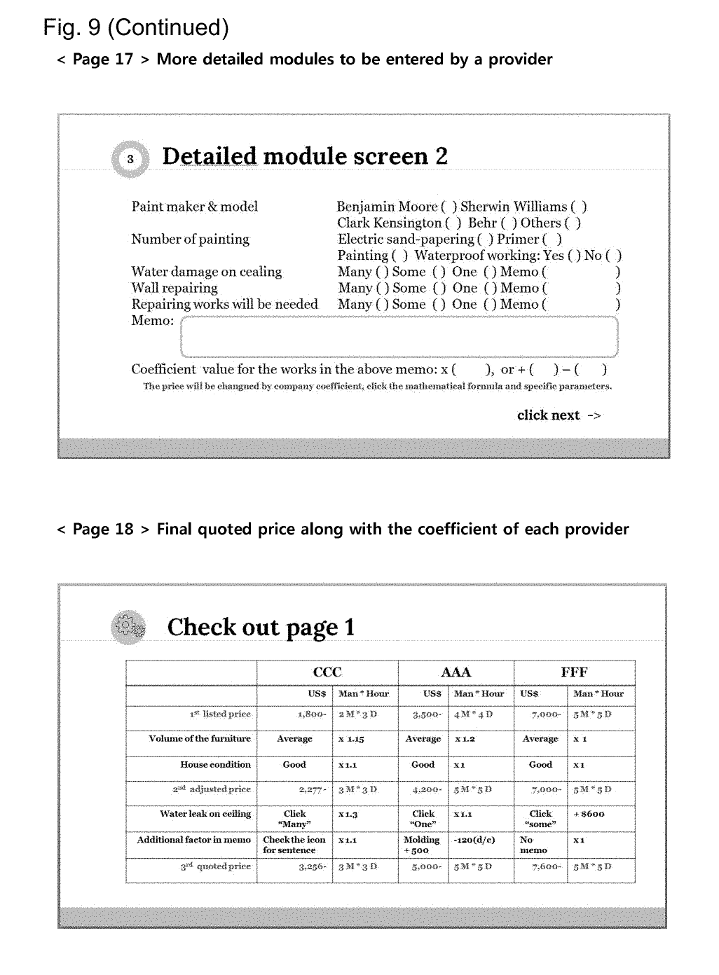

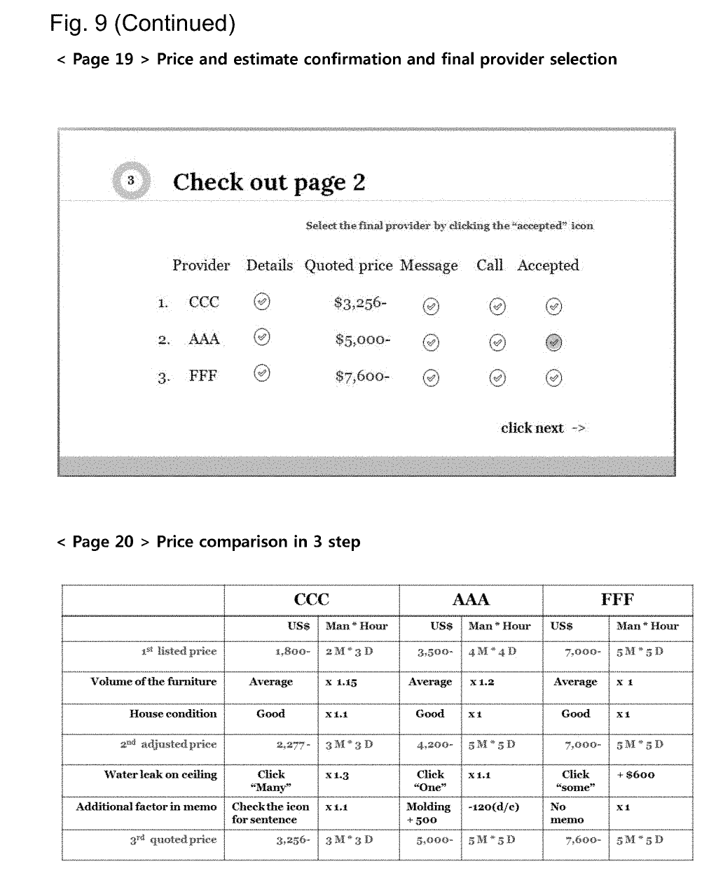

The system that populates the price comparison chart that changes throughout the stages (Step 1˜3) along with the provider's own coefficients which helps the client to recognize the price computation process. (The sample is shown in the page 18 of FIG. 9).

### Invention Point 13

Once client/provider confirms and the revised information that includes the provider/client's location, weather condition, and distance between 2 parties, selected service's module and new description/memo on the estimates, the AI system automatically populates the contract form through the communication exchanged between 2 parties and clicks the “agreement” icon or “sign” at the estimate/invoice.

Invention Point 14 (The function to set the company grading rate)

AI system has the grade rating function based on the various elements such as the company's profile (e.g. the year of establishment, number of years with the number of projects, the total sales, the number of employees, work schedule, insurance and license availability, the number of projects with “Cliencom” and client's review.)

### Invention Point 15

It is the system that the service categorizes and separates out the one by one so that client could leave the reviews about contracted service provider only. Once the client clicks the specific category, they could view the reviews only specific category. Also, the provider can leave the comments below the client's review.

### Invention Point 16

There is a provider's available language option in the provider's introduction page so that the various language speakers could contact with the providers in their own language and then clients have the consultation from the providers with available language at the stage 2 and 3.

### Invention Point 17

The AI system organizes by the service category and learns sentences and memo entered by providers, and therefore the AI system set the company rating by putting the point value for each provider depending on the number of times the provider has entered memo and sentences related to the service and the number of using the memo and sentence in the estimate (contract).

### Invention Point 18

The AI system set the company rating by putting the point value for each provider depending on response time of providers to text inquiries of clients.

### Invention Point 19

The AI system automatically generates a warning message to the O2O business model system for auditing the provider to determine fraudulent activity

### Invention Point 20

The AI system sends a warning message to help the provider to input a reasonable price for the service modules.

### Invention Point 21

The AI system helps Cliencom to rearrange the contract terms according to the types of services.

### Invention Point 22

The AI system and server display the A/S period of the various type of service on web/app.

### Invention Point 23

The AI system display the A/S period and contract terms for the various service tasks to the client under Cliencom approval.

### BRIEF DESCRIPTION OF THE INVENTION

The server furnishes the various data that can be identified the grade rating of the company that will be commissioned the services about the store service (various services to visit and get the service at the provider's store.) and indoor service (maintenance, repairs and interior works related to the real estate). It formulates the standardized modules of the various service categories' basic data. Also it helps the client to check the price that is revised in each stage by 3-step pricing rule that is based on the modules, provider's coefficient and external environment conditions.

With artificial intelligent O2O business model, the server assists the client/provider to confirm the systematic estimate, invoice and contract before they sign the agreement.

### TECHNOLOGINAL BACKGROUND OF THE INVENTION

People tend to have a less fear when they are able to predict the future events and want to live happy lives. However, unlike the price marked items sold in the market or online, service price cannot be quantified and standardized easily because the difference of company's technology. Thus, the clients tend to be fearful about the service as they cannot predict the price and they more likely feel unsatisfied after they receive the service.

When it comes to the service market, it is difficult to visit each store to compare their service with its competitors as it is too time consuming. Especially when clients need to repair their houses such as the water heater during the winter, A/C during the summer, water pipes leakages, they find difficulty in finding the right company within a short period of time.

To find the right service company, customers need to calls with various companies to receive the quoted price and have to make the decisions on their own based on the limited information they get the consultation a few companies. For example, each company has a different price range based on their own policy and there is not enough feedback about the companies.

It is also fearful to just rely on friends' recommendations because if the customer is independent and logical, it is uneasy for him to trust the recommendation of the friends who are not in this service industry.

### REFERENCE

1) It is difficult to find out the optimized price and good company.
2) Customer does not know the pros and cons of company with a phone call.
3) It is difficult to check any disadvantage of the company who offer the lower estimate.
4) There is no way to identify a company that does not provide the service after the deposit.
5) It is difficult to screen the friendly company even they have the contract.
6) It will be difficult if the company asks the additional payments to customer during the service processing without the detailed contract sheet.
7) There is some customer who does not receive the satisfaction service even though the contract with a large company in a sufficient payment.
8) Customer could not complaint with the service works that is different than the expected.
9) Customer could not appeal to the company if they do the service works unfaithfully.
10) It is difficult to find out the after sales serviceable company.

### PURPOSE OF INVENTION

This online and mobile marketplace is built to connect the customers with the service companies by providing them all the information they need in order to choose the right companies efficiently and effectively. It is also designed to benefit the companies by assisting them to be visible and market themselves to their potential customers easily through our platform. More details are shown on the figures and indexes included on the following pages.

### PROBLEMS OF THE EXISTING METHODS

When the major companies handle the projects, they take a full ownership throughout the assignments and provide high quality service. For example, they provide long pages of contract and lead the consultation meeting professionally. However, when small local companies handle the projects which are smaller and less complex comparatively, there are many problems in finding the reasonable quoted prices as listed below:

First; It is difficult to find the right company

Online search engines help the customers to find the websites, blogs, or advertisements but these don't provide the service in national-wide to all of the local customers. Therefore they need to check Yelp, Yellow Page, flyers or other local advertisements to find the companies.

If they call the companies, they need to explain the situation verbally. Also, if they use online services, they need to write their requests but which makes them difficult to complete their request as they have no related technical knowledge.

If the project volume is too small, companies don't usually provide the quotes and don't even answer the questions nicely when they receive calls. They don't even visit the customer venue when they are asked to do so. Frankly, both major and small companies tend to avoid visiting the customer venue if the projects are too small. Therefore, customers usually contact 2˜3 companies and make a decision based on the basic knowledge that they gain from the consultation meeting.

Second; Recently people can't let anyone from untrustworthy companies visit their houses especially they only know the phone numbers.

Third; It is difficult to compare the companies as they offer different price ranges and estimated length of work as the most of customer does not know the related technical knowledge.

Also, it is difficult to trust some handymen and to get the small companies profile as they don't have company websites. It is uneasiness to make a deal with a honey tongued sales people.

Fourth; When the companies charge the customers for the overtime in case they charge hourly, it is hard to approve it as they can't find out how accurately the overtime is calculated.

Fifth; It is difficult to find the insured and licensed company. If the customer makes a contract with uninsured and unlicensed company, he will need to be responsible for any accidents or damages occurred during the project. If anything happens, customer might be involved in a lawsuit.

Sixth; Companies might not offer after-service Service. They might try to avoid taking responsibility for damages or incomplete work when customer chooses the wrong company with insufficient information.

Seventh; There is a possibility the burden may be increased with the unnecessary extra costs due to the unprofessional technician or handyman might replace a wrong part.

Eight; If the customer makes a contract with a small company using a simple, low quality contract, he can't control the project in case of conflict so that customer gets the dissatisfaction with outsourcing company and disappointment rather than kindness.

Ninth; There is a difficult to compare the companies' quoted prices, technical knowledge and service quality in case of the customer visits to the several stores.

### CURRENT TECHNOLOGY

These require a lot of effort and time for the customer as he needs to contact each company and meet them to gain basic knowledge in regards to the projects after the finding out the telephone numbers on web site, local magazines, flyers, Yellow Page and or Yelp.

### Yelp

Yelp lists out the service companies based on the category which is better than Yellow Page, but it is not systemized and structured. It doesn't have the discernible grade rating system and specific price list for each company. It has a customer review section but this cannot be a key factor in choosing a company.

Also it is designed for the customers to request the quoted price to the listed companies, which is uneasy without the technical knowledge about the service project. Therefore, the most of listed companies does not release the estimates as customer requests are usually unclear and not detailed enough for the companies to measure the project and Furthermore, Yelp does not assist the customers throughout the contract making process.

Therefore, customers have to call the companies and ask for the estimates and even if they receive it, because of the un-standardized format they cannot easily compare the estimates' that including various phrases, unfriendly simplified phrases, omitting phrases, and arranged phrases differently versus price.

### TaskRabbit

This is an online and mobile marketplace that connects customers with freelance labors, allowing customers to find immediate help with everyday tasks such as cleaning, handyman, moving & lifting, delivery & shopping, general help and handyman.

Handyman work is very limited that it does not unsuited for the purpose of the complex professional tasks that need the license or insurance.

### TECHNICAL CHALLENGES OF THE INVENTION

### Structure and Action if the Invention

There are many places that compare the prices of manufactured products online but there is no place that compares the estimates issued by the various kinds of service companies.

This invention provides the price comparison service to the clients so that they can make educated decision when they choose the service company through the modules of the companies along with their coefficients.

### STORE SERVICE

Here are samples of the service types that client should visit to store or shop;
Beauty Service
Spa & Massage, Hair Salon, Makeup Artist, Rolfing, Skin Care
Local Service
3D printing, Elder Care Planning, Funeral Service & Cemeteries,
Furniture Rental, Jewelry Repair, Screen Printing,
Automotive
Auto Customizing, Body Repair, Car Stereo Installing, Inspection,
Glass Installing, Road Side Service, Tires, Towing Service
Event & Wedding
DJs, Flower Artists, Magician, Bands, Party & Event Planner,
Party Equipment Rental, Photographers, Wedding planning,
Professional Service
Business Consulting, Graphic Services, Marketing Service, Product Design,
Web Design, Security Services

The following modules are the explanation in more details for some of the above sample service;

1) Service with Simple Modules (Example: Service for Tire Exchange)

| Price in Stage | Modules of the tire exchanging service |
|---|---|
| 1^{st} listed | The list price is generated the tires' price of the various |
| price | manufacturer's tire model with the vehicle model, trim |
| | level and model year. |
| 2^{nd} | The adjusted price is generated for 3 selected providers |
| adjusted | among the providers with the variables such as the |
| price | labor cost, technical support fee, used tire's refund |
| | availability, wide tire model, etc. |
| 3^{rd} quoted | The quoted price is generated after the consultation |
| price | meeting. (additional tasks might be added during |
| | the meeting) |

### REFERENCE

“Cliencom” app may not generate the estimate proposal, invoice, and terms of condition for the service under $500 contract value, the specific service types and the unsophisticated services.
   2) Service with Complicated Module as Various Options (Example: Web Design)

| Price | |
|---|---|
| in Stage | Modules of the web design service |
| 1^{st} listed | Web design works for single product or shopping mall |
| price | |
| 2^{nd} | Main page design draft proposal (2, 3, 4, 5, >5 types) |
| adjusted | Web page design draft proposal (10, 20, 30, 40, 50, >50 pages) |
| price | Sub page design draft proposal (1, 2, 3, 4, 5, >5 pages) |
| | Product details page design draft proposal (2, 3, 4, 5, 6, 7 pages) |
| | Illustration image design draft proposal (1, 2, 3, 4, 5, >5 images) |
| | Mobile web page design draft proposal (2, 3, 4, 5, >5 types) |
| | Multi-media (video, flash, GIF animation image) <3, <5, <10 |
| | pages |
| | System build-up, application production |
| | Bulletin board (<2, <5, >5 pages) gallery (<2, <5, >5 pages), |
| | History management, Membership function, Coupon function, |
| | Shopping mall (basket, my page, goods registration, credit card |
| | payment functions) <3, <5, <10, <20, <30, <50, >50 pages |
| | Administrator page build-up |
| | Refurbish product shopping mall function build-up |
| | Number of Icons, FAQ & AS page, Pop-up function, |
| | e-mail confirmation function when client's order or cancel, |
| 3^{rd} | Additional price for client's special functions |
| quoted | |
| price | |

“Cliencom” app helps the client to expect the accurate price range for the various service categories using 3-step price rule. It also connects the client with the providers through the built-in messenger system.

### INDOOR SERVICE

Here are the samples of the service types that providers should visit to client venue;
Moving
Home Moving, Automobile Moving, Home Inspection, Pest Control,
House Cleaning, etc
Maintenance:
Hot water tank, HVAC, Water purifier, Gardening, Snow Removal,
Electrical, A/C, Keys & Locker Smiths, etc
Repair:
Faucet, Toilet stool Replacement, Carpet, Jacuzzi, Wall, Roof,
Water Leak Repair, etc
Interior:
Painting, Countertop Installing, Kitchen, Bathroom Remodeling,
Flooring, Store/Shop Interior, etc

Real estate (house, store, shop) related maintenance, repair, service projects can also be modularization with the 3-step stage rule. The providers will do their best for the project received order through “Cliencom” that provide the AI company grading system, messenger tool, standardized estimate/invoice/contract generating system so that “Cliencom” will create a pleasant purchase environment for both clients and providers. Also it will be qualitatively different from the existing transactions.

### HIGH CLIENT SATISFACTION

1) The client satisfaction will increase if clients don't have to call the providers individually.
   Clients will also be satisfied if the following problems are resolved.
   a) Is the quoted price (provided by the company after the roughly visiting) appropriate? b) Is the price not high and proper?
   c) Is there any company that offers more affordable price?
   d) Is this company reliable?
   e) Is this company insured?
   f) Is this company diligent?
   g) Most of clients have a lack of technical knowledge for the specific service.
   h) Clients may not trust the service company if they have contract with one.
   i) Clients may uneasy when they have a contract without the details.
   j) Clients do not have the happy memories during the projects if contractor does not friendly.
   k) Clients feel it is difficult to ask the after-sales service, etc.
      It will assist the client
      to choose the module logically (for the service that is a lot of quoted price deviation) using the listed categories including company grade rate, company sizes, their service area, their prices, profile, performance level, history, license and insurance availability, client rating etc.
      It gives the first step price range based on the standardized modules in the Step-1 stage so that the client can get an idea of the list price of the selected service category. The system also allows the client to compare the providers along with their offering prices to fit the budget.
2) Most of the people do not want to anyone from untrustworthy companies visit their houses, If client using “Cliencom”s app/web, clients will feel much safe and comfortable when contacting the providers as “Cliencom” filters out reliable providers through its compliance system.
3) Through “Cliencom”, provider will arrange client's home visit and explain the project during the visit before they make the contract. During the visit, they will update the modules together if they find anything to edit or add for the project. The price will be adjusted automatically based on the updated modules so that they both can see turn-key based price.
   The app will show the formulas that bring the selected provider's prices in each price filtering stage so that the clients will be able understand where the prices are coming from. (Page 18 in FIG. 9).
4) Using “Cliencom” app, client can make a contract with a reliable and trustworthy provider and client can make a claim if the project or service does not process as per the contract.
5) Since there is a client review system, providers will perform work sincerely and diligently throughout the project.
6) With “Cliencom” standardized estimate, invoice and contract, client will be able to sign a reasonable and fair contract.

### HIGH PROVIDER SATISFACTION

1) Providers can be connected to the clients without advertisement cost through “Cliencom”. Also, as the clients are connecting them after they compare the companies' profiles and the list price through “Cliencom”, it will be much more efficient and effective than other marketplaces Yelp, Yellow Page, local magazine and flyers.
2) Once clients request the service modules, they will be able to answer clients' questions effectively as they know the client's selected modules. Through the sufficient communication and information exchange, clients will be able to understand the project and more likely make the contract.
3) Once a client requests the consultation meeting to the provider within his service boundary, “Cliencom” will inform client's selected modules, service type, and request date/time to the providers automatically so that they can use the information during the visit.
4) To assist the providers getting paid for their consultation visiting cost, the client will make a small payment (that will apply toward the project fee) before the consultation meeting so that the probability of contracting is higher than other marketplaces.
5) Using the tablet PC, provider will be able to select the modules with his client and take a memo and sentence to populate the estimate, invoice and contract by clicking the preformatted sentences from their DB with the client.
6) If the size of the provider is big, they can increase their estimated price.
   The providers can also maximize the revenue by increasing their price once their company grade goes up. They can differentiate themselves from their competitors in “Cliencom” by posting their profile (company history, portfolio, sales amount, company body, work schedule, license and insurance availability etc) and store own customized sentences and memo on their own data base in “Cliencom”.
7) If the work is scheduled by schedule, the provider's work efficiency will be maximized through the scheduled appointments.
8) Both client and provider will maintain fairness of the contract through standardized estimate, invoice and contract terms.

### OPTIMIZED ESTIMATE (OPTIMIZED QUOTATION)

“Cliencom” server will generate the customized estimate so that the provider can earn client's trust while the client gets less pressure on requesting service. 1^{st} and 2^{nd} stage modules will be selected by the client and the prices will be generated based on the coefficient and pre-set prices entered by the providers. This will help the client to narrow down the providers up to 3 among many of them by comparing the listed prices in stage 1 and adjusted prices in stage 2 along with the grade rate.

There are many variables to consider when a “Cliencom” server populates the quoted price in 3^{rd} stage during the consultation visit.

For example, in painting service:
a) Poor house condition,
b) Poor ceiling and wall condition due to mold and water leak,
c) Current paint is lead-based paint,
d) Components such as doorknob and decorating items need to be replaced additionally,
e) Extra workers such as electric, water pipe, gas technicians, and carpenters need to be added,
f) Waterproof construction needs to be added,
g) The house condition is worse than information received from the client,
h) Number of workers and schedule need to be extended,
i) Other reasons that the provider can't process the service with 2^{nd} adjusted price,
j) The work is less complicated than expected that the provider can discount the price,

Providers can be prepared for the above various situations on “Cliencom” as it provides the followings;
1) Detail module that allows the providers to make decisions with the client,
2) Auto memo/sentence generating mode that allows the providers to write the memo/sentence by selecting pre-set sentences/coefficient from its own customized data base,
3) The mode that allows the providers to revise or add work manually with the client,
4) Many types of coefficient input module for adjusting formulas,

The “Cliencom” system that populates the finalized customized estimate based on the detail module, memo, and coefficient values.

### OPTIMIZED INVOICE/CONTRACT

All the trouble starts from unorganized and weak contract. If the contract is too simple and vague, it will cause a fault service along with the lack of job responsibility. “Cliencom” will prevent this result by providing the optimized invoice/contract which is derived from the optimized estimate. (“Cliencom” will highlight the memo/sentence that has been added to the specific project in addition to the contents listed on the standardized template of the invoice/contract so that the provider can confirm these lines easily.)

This high quality detailed contract will do the followings;
1) It will lead the project to completion as the expected and planned.
2) It will eliminate the conflict between the client and provider by assisting them to anticipate the expected result in advance
3) Client satisfaction level will increase upon the completion of service

### CONCLUSION

### <Efficiency and Value of Service Company/Store Comparing Functions>

The elements that increase the client satisfaction toward service include provider's high technology, prompt and accurate business handling, client service, business progress notifications service, and A/S availability. Also, the elements that increase the client satisfaction toward local store/shop include interior environments, equipment types, client services, professional skills, and sincere response to the client's questions etc.

However, even if the service companies/store/shop wants to provide the best service, the clients cannot be satisfied since there is no such price and service comparing system in the current market. Therefore, the local companies cannot easily gain clients' trust and proceed to make the contract. Moreover, they cannot easily satisfy the clients' individual tastes only with their own effort and resource.

Therefore, if there is a platform that compares the prices and standardized profiles of service companies/stores/shops, clients will be connected to the service providers more effectively and both of them will enjoy a better service environment. Also, it will increase both trust and satisfaction of the clients as it assists them to make a sophisticated choice in choosing the companies/stores/shops.

Lastly, the systematic platform will lead the service providers to offer their best service to the clients using “Cliencom” client review and company grade system. Moreover, through “Cliencom”s built-in grade level system, the service companies' grade rate may be automatically decreased or they may even be suspended from “Cliencom”. This policy will lead them to provide honest and accurate service which will increase client satisfaction and help them to build trust with the clients.

### DETAILED DESCRIPTION EMBODIMENTS OF THE INVENTION

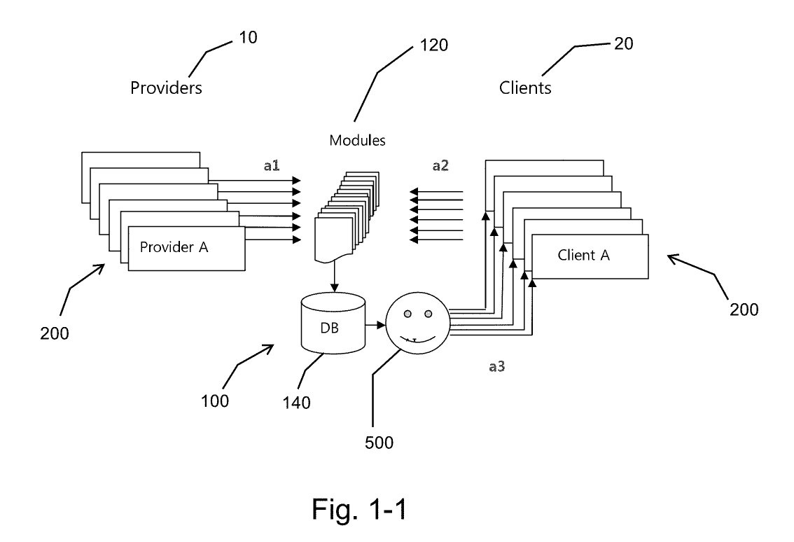

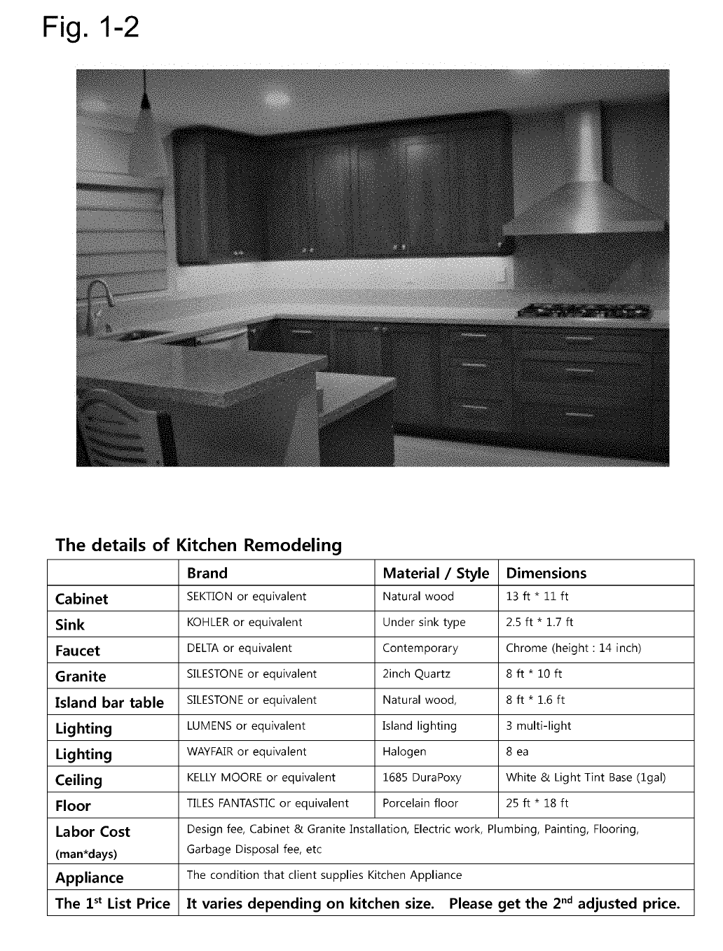

FIG. 1 Shows Modules for Generating the Price.

There is a menu (a1) that “Cliencom” providers can input the module price with their profile and service types.

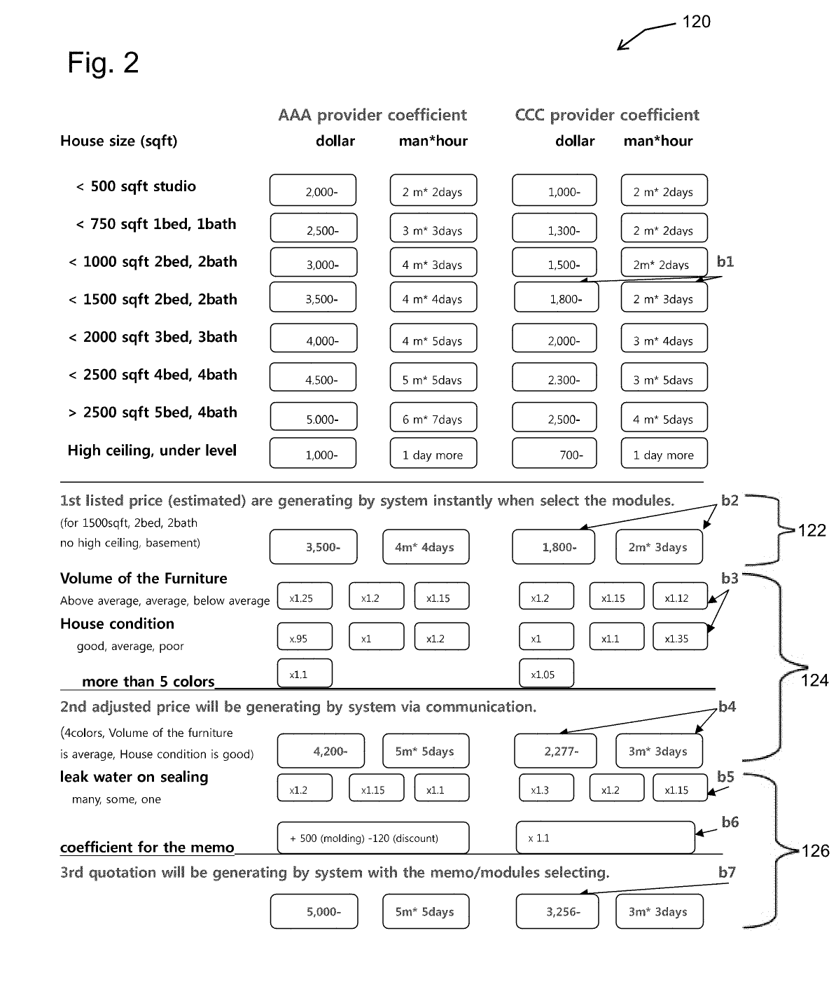

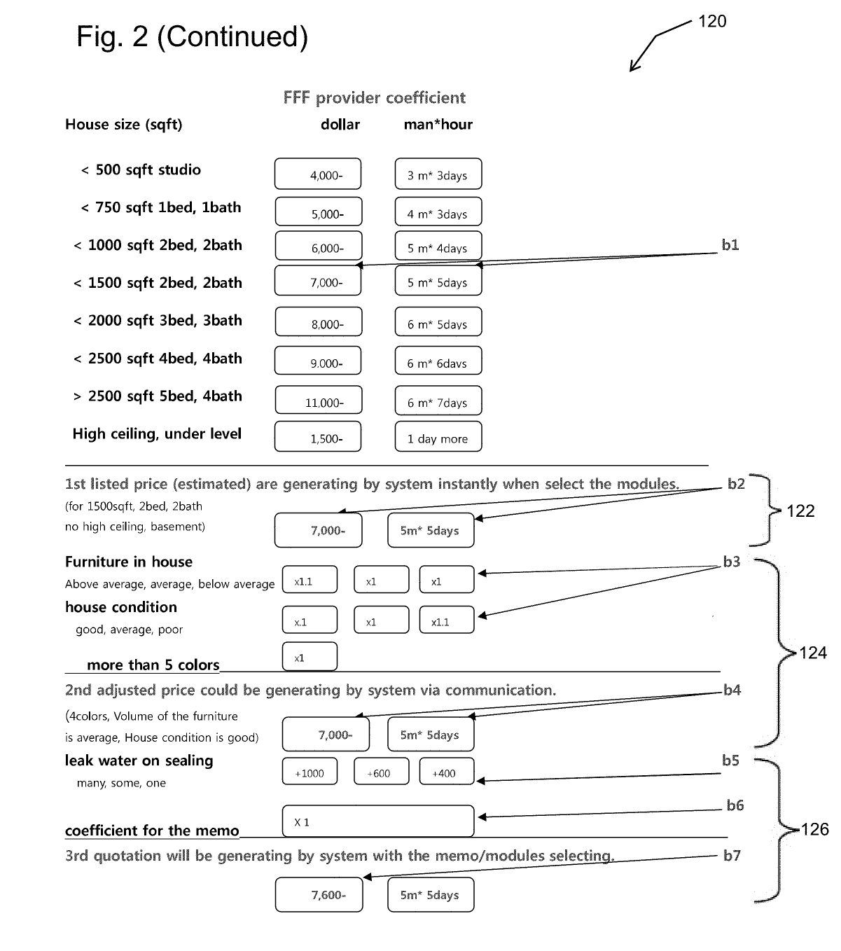

For the small scale projects, “Cliencom” recommend the providers to quote the services at slightly higher price, with embedded base price coefficients (for example, painting service; there is sample values based the house size as shown in FIG. 2) factor for each provider. On the other hand, for the large scale projects, “Cliencom” recommend the providers to quote the service at slightly lower prices. The reason for high pricing for the small projects is because of the same attention to details required for the each projects.

To become a provider, it should enter the number of employees, the total sales, office related expenses such as they maintenance fee and rent expense, and other monthly expenses such as the license maintenance expense and insurance expense, covered geographic range for the service, available language etc.

Once the client selects the service module (a2), he can review and compare the provider profiles, company grade rates, client reviews, and 1^{st} listed prices (a3) of the providers listed within the selected geographic range. (Please refer to FIG. 9)

### FIG. 1-2 Shows a Kitchen Remodeling Photo Sample for 1^{st} List Price.

The invention provides pictures and associated items and service prices for such modules, so that the client can compare the first module prices easily. In the illustrated embodiment, the modules are displayed with pictures.

### Example of Service

### FIG. 2 Shows Modules for Providers, for an Exemplary Case for Painting Service.

The customized turn-key based list price will be generated once the providers enter the module price and coefficient of detailed option.

To populate the 1^{st} listed price, the provider needs to select the price for the detailed options such as house size and number of rooms and bathrooms (please refer to b1). Also, the providers will appear on the map when it selects the geographic range for the service.

The provider's 1^{st} listed price (b2) will appear when the client selects the providers from the map. The 2^{nd} adjusted price (b4) will be generated by the provider's own coefficient (b3) when the client selects more detailed options such as the amount of furniture and the house condition after the phone communication.

Finally, the 3rd quoted price (b7) will be generated by the provider's own coefficient (b6) when the provider revises its coefficient (b5) for the project and adds the extra work on the memo line during the consultation visit.

Throughout 3-step price rule, the client will be able to see how the final quoted price is determined and get the estimate in PDF based on the discussed work assignment. Therefore, he will feel comfortable about the price and will be able to make a contract with provider with the confidence.

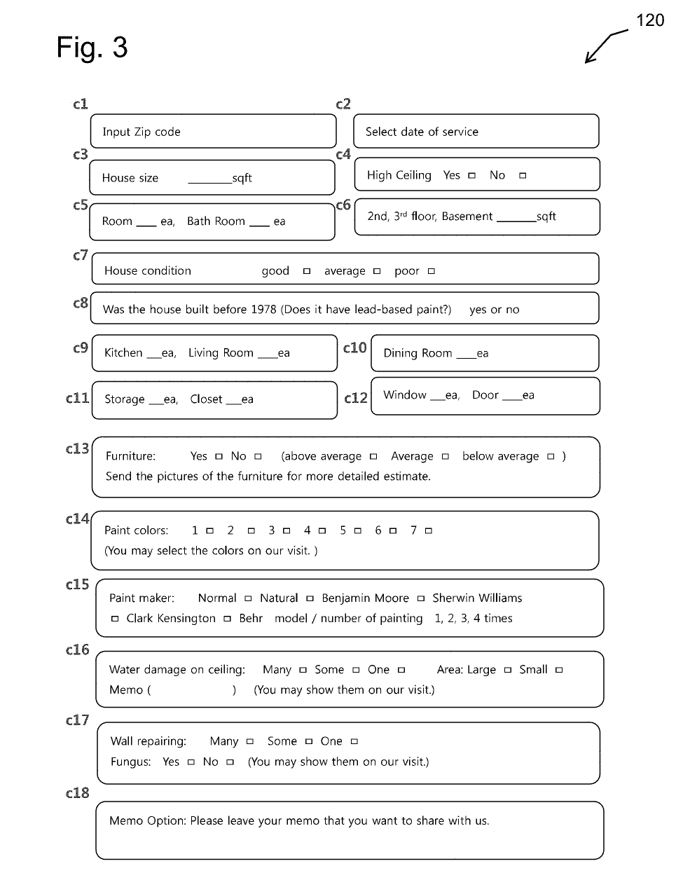

### FIG. 3 Shows Modules for Clients for an Exemplary Case of Painting.

For example, client can use “Cliencom” to populate the estimated price by selecting the following factors from the modules;
(c1) House location (Client needs to enter zip code to narrow down the geographic range.)
(c2) Date of service (The providers that are available on the selected date will appear on the map.)
(c3) House size ______ sqft
(c4) High ceiling; (Longer work hours will be estimated as the high ceiling requires ladders.)
(c5) Number of room and bathroom; (Work hours will be extended depends on the number of walls.)
(c6) 2^{nd}, 3^{rd} floors or basement ______ sqft
(c7) House condition; (house condition or wall condition will affect the estimated price. For example, if the surface of the wall is rough, the labor needs fix it using scrapper and sandpaper which will take longer amount of hours than the painting for the house with a normal condition.)
(c8) Was the house built before 1978?; (The paint that was used before 1978 contains lead. So that the process to remove the paint is very complicated as it requires professional skills.)
(c9) Number of kitchen and living room; (This is not a required module unless it is a mansion. The estimate will be changed if there is more than one.)
(c10) Number of dining room; (There are open and closed styles. It will take longer to paint a closed style.)
(c11) Number of storage and closet; (The work hours will be extended depends on the size of storage and walking closet.)
(c12) Number of window and door; (The work hours will be extended will the client wants to paint the window frames in different style or color.)
(c13) Amount of the furniture; (The work hours will be extended if there is furniture inside of the house as the labors need to remove it before they start painting and return it after the project.)
(c14) Number of painting colors; (It will take shorter amount of time if the client selects one color. Usually, the companies paint the ceilings, walls, mold, window frames, and door frames in white and paint the wall in a different color after discussing with the client. If the client chooses various colors, it will take longer hours to paint the whole house as the workers need to differentiate parts using either tapes or brushes.)
(c15) The brands of the paint; (The price would be changed a little bit based on the quality of paint brands. High quality brands include Benjamin Moore, Sherwin Williams, Clark Kensington, Behr, etc.) The price also would be changed based on the number of layers. (The client can choose number of painting from 1 to 4 times. Also, the use of nature paint, size of the primer needed area, use of 100% acrylic paint, and colors will be determined during the consultation visit.)
(c16) Water damage on ceiling; (If there is some water damage on ceiling, the ceiling board will need to be replaced for the longer paint lifetime.)
(c17) Fungus; (If the area is a basement, the water proof construction needs to be added and wall board needs to be replaced before the paint work for the longer paint lifetime. This will cause longer amount of work hours.)
(c18) Client's memo options; (Transmission available functions for the memo or photos.)

Other things to concern:

Weather is another factor that affects the painting cost. “Cliencom” uses weather forecast through AI software to estimate the accurate price.

When the provider selects the additional modules to the memo line for the extra work during the consultation meeting, these lines will reflect on the estimate. This tool helps to build trust with the clients as it helps them to communicate with their clients transparently.

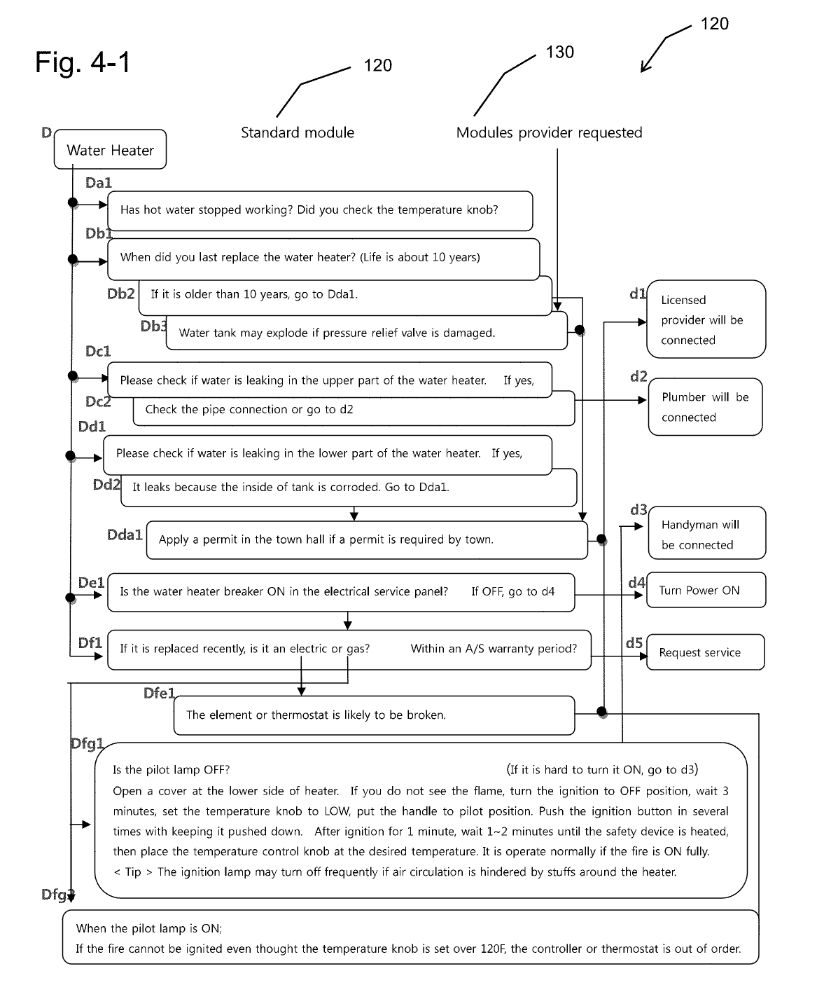

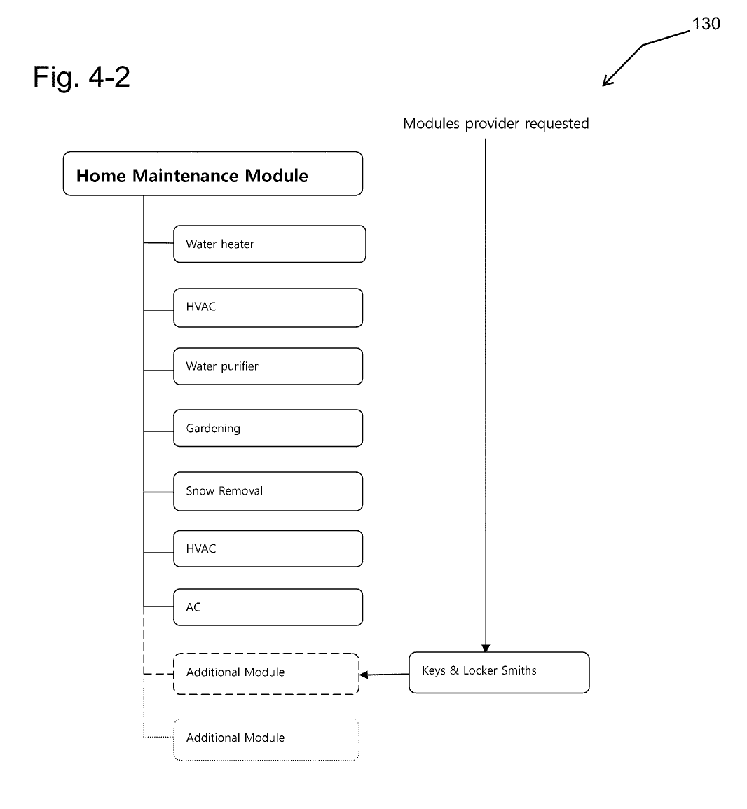

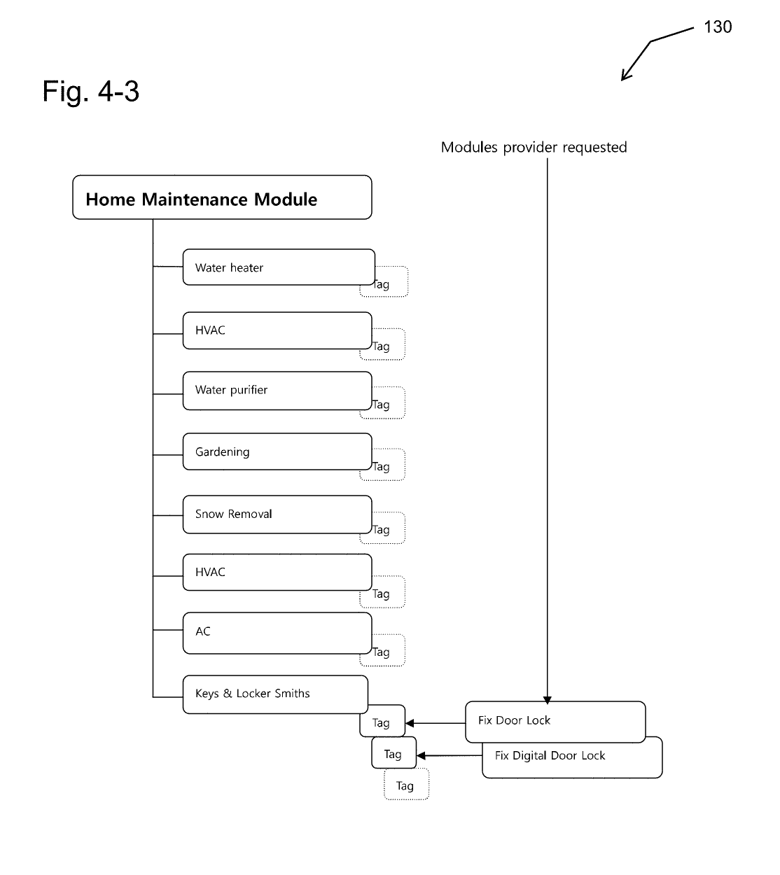

### FIG. 4-1 Shows Augmented Modules System for an Exemplary Case of Water Heater.

While most of the services require basic and listed expressions modules, there are some services such as a water heater service that require branch classification modules. In other words, there will be sub modules (Da1˜Df1) under basic modules (d), and sub-sub modules (Dfg1˜Dfg2). under sub modules (Df1),

Here are the ways to add sub modules:

1) To add the exclusive modules those are shown under the specific provider only:
(a) They can create an additional module—This will not be shared with other companies.
(b) They can add sub-modules under each module when necessary by clicking a tag.
1) In order to have the member company shown to the client only,
since water heater is a complex module, the addition of modules is going to be described in the Home maintenance module, an upper level of the Water heater:
(a) In FIG. 4-2, if the provider input the serviceable module in the additional module, a simple service item appears and the client gets to know the price on clicking it; and
(b) In FIG. 4-3, if clicking the tag of the module and inputting in the memo, the client can select and get to know the price of service.
If one provider can perform a specific service, the client cannot compare the prices and the provider will have a hard time to get an order. After a given time period, Cliencom opens the fact and open to the public, making other providers that can provide the service input the prices.
   2) Augmented modules that are publicly shown on the platform:
“Water heater damage” module in FIG. 4-1 is explained as the followings as an example.
   Once the provider selects “water heater” as a standard module (D), they can name the affected area related categories in Da1, Db1, - - - Df1 under D and keep the register open for the sub modules under Da1. The provider can keep this open register for future sub-modules so that once they determine new sub-modules, these can appear immediately when “Cliencom” approved it.
For examples, if the provider clicks a tag under Db2 and create a sub-module called “Water tank may explode if pressure relief valve is damaged,” this new module (Db3) will be created upon “Cliencom” approval.

### REFERENCE

If these new modules are constantly created voluntarily by the providers, it will create a better service environment and help O2O market place to be more attractable to both clients and providers.

Electric and gas water heaters require different diagnostic approaches. In this case, the modules can be split at Df1 and divided into 2 separate paths by assigning electric water heaters as Dfe1 and gas water heaters as Dfg1.

Depends on the modules selected by the clients, “Cliencom” will proceed to either next steps (d1-d3) or closing stage (d4-d5). If the defective area requires a simple service such as turning on the pilot lamp, “Cliencom” will proceed to the handyman (d3) category which will cost less than the providers. If it is a complicated project (Dfg2), “Cliencom” will proceed to either licensed provider (d1) or plumber (d2) category which can provide professional service.

### In FIG. 4-2 Showing Augmented Modules System (Additional Module),

one of the providers inputs the serviceable module in the additional module, a simple service item appears and the client gets to know the price on clicking it.

### In FIG. 4-3 Showing Augmented Modules System (Module's Tag),

one of the providers clicking the tag of the module and inputting in the memo, the client can select and get to know the price of service.

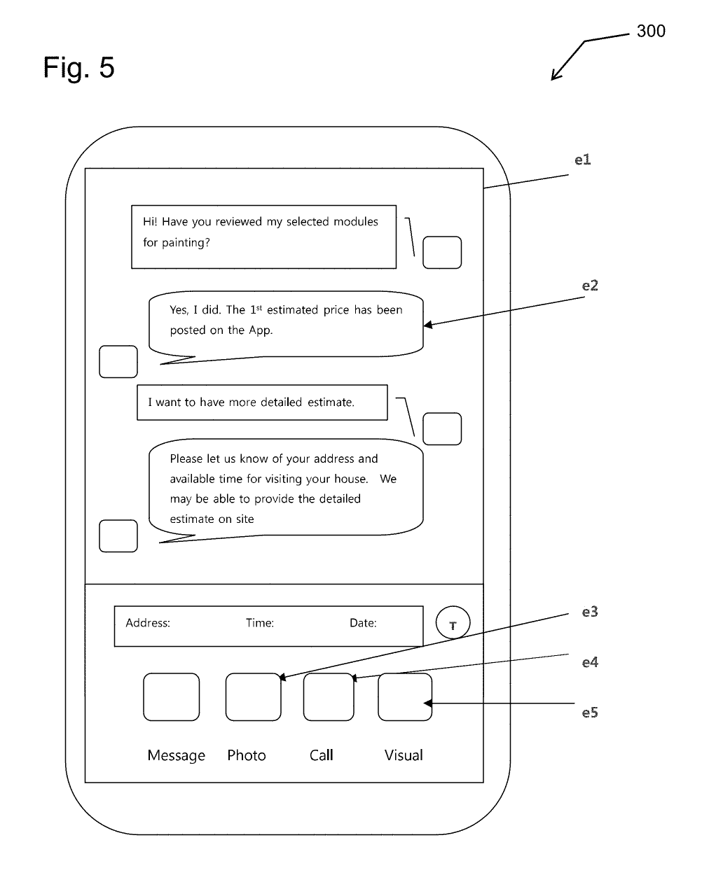

FIG. 5 Shows an Example of the Chat Window for Client with Provider.

The chat room allows clients and providers to exchange communication such as texting, voice call, and picture message.
(e1) Client sending a text sentence to the provider
(e2) Provider replies
(e3) Picture message option
(e4) Voice call option
(e5) Visual call option

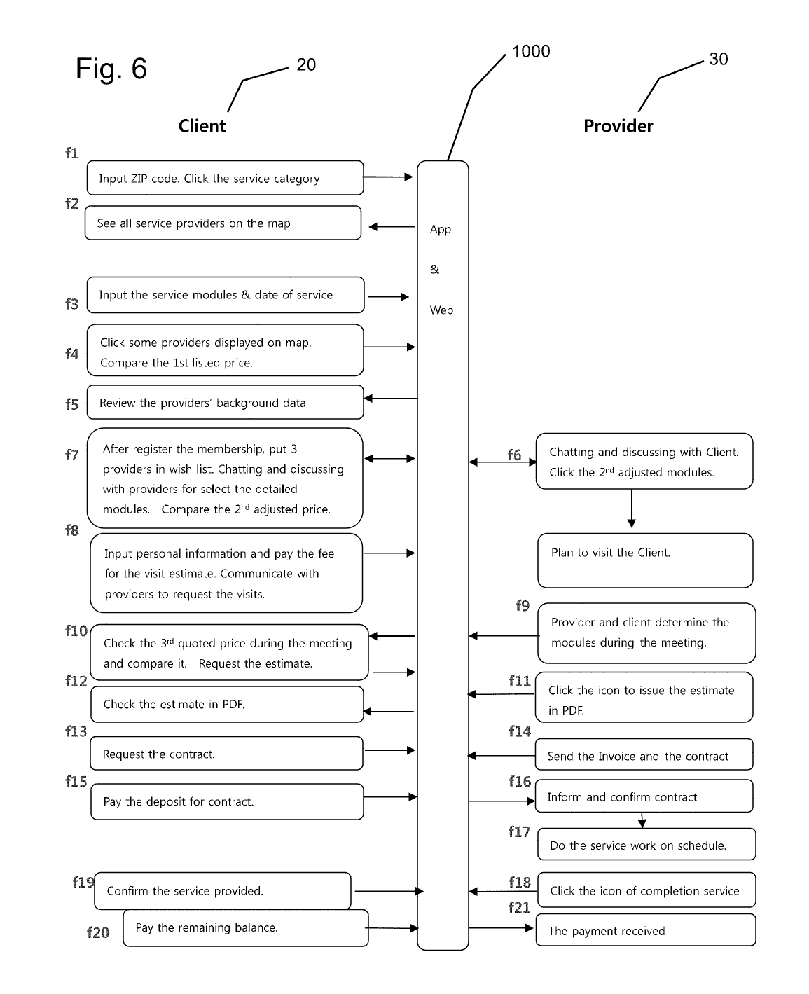

### FIG. 6 Shows Business Flow for Client and Provider.

When the client enters the zip code and selects the service category (f1), the available providers will appear on the map (f2).

When the client registers to “Cliencom” app/web using his email and password and enters the service module and date (f3), the available providers will be sorted out accordingly and will be highlighted (f4). Also, when he clicks the list button in the right bottom of the page, he will be able to see the provider list in price order.

When the client clicks the providers' name, its profile (such as company size, license, insurance, portfolio, grade, client review) will appear along with the 1^{st} listed price (f5).

If the client likes certain providers, he can move up to 3 providers to his wish list and enter more detailed modules to populate the 2^{nd} listed price. If he doesn't have any professional knowledge, he can contact the providers by messenger (f6) and select the additional modules. Even if he contacts one of the three providers, once he selects the additional detailed modules, he will be able to see all 3 providers' 2^{nd} adjusted prices (f7).

### REFERENCE

2^{nd} adjusted price reflects the variable factors such as whether the location is a construction area, temperature, humidity, catastrophe, most current minimum wage, etc.

Client can request the consultation visit (f8) to get the customized estimate. When he requests the visit, “Cliencom” will ask for the consultation payment (in this process, client should be entered his name, address and cell phone number, and become an associate member. If they make the contract, this consultation payment will apply toward the invoice. Once the client signs the contract, he will become a regular member and he will get the service related information electronically).

Some factors that generate the 3^{rd} quoted price at the consultation meeting include the area where the caulking compound, surface removal, sanding, or wood filler needs to be applied.

When the provider finalizes the modules and coefficients (f9) after having the client's consent, 3^{rd} quoted price will appear immediately. Upon the client's request (f10), the provider can process the customized estimate (f11).

### REFERENCE

1) 1^{st} listed and 2^{nd} adjusted prices can be reviewed and compared immediately as the modules that derive theses prices are selected by the clients and each provider's coefficient for the selected service modules are pre-set by the provider. On the other hand, the 3^{rd} quoted price is determined uniquely by each provider as their ways of approach toward each project are different and they may select different additional sentences and memos at the consultation visit. If the specific modules are not listed in the system, they can add the factors to the memo line so that these can be reflected on the 3^{rd} quoted price (FIG. 9, page 18).
2) Even if the contract is not established after the consultation visit, the company will still be paid for their visit. This consultation payment (if all 3 providers make consultation visit, this payment will be divided by 3 and distributed to all 3 providers equally) will be made when the client schedules the meeting. This payment will be distributed quarterly.

After the client confirms the estimate (f12), he can request (f13) the contract and receive the invoice and contract (f14). Once he pays the 1^{st} half of the payment (f15), the app will inform the provider and confirm the contract with them (f16). Then, the provider will perform the service on the scheduled date(s) (f17).

Once the provider completes the work, it will click the “service completed” icon (f18). As soon as the client confirms it (f19), he will be asked to pay the remaining balance/2^{nd} half of the payment (f20). Then “Cliencom” app will release the 1^{st} half of the payment to the provider (f21).

“Cliencom” app/web will hold onto the 2^{nd} half of the payment and will pay the provider after the end of the A/S period. After A/S period, the provider-client chat room will be closed automatically.

### REFERENCE

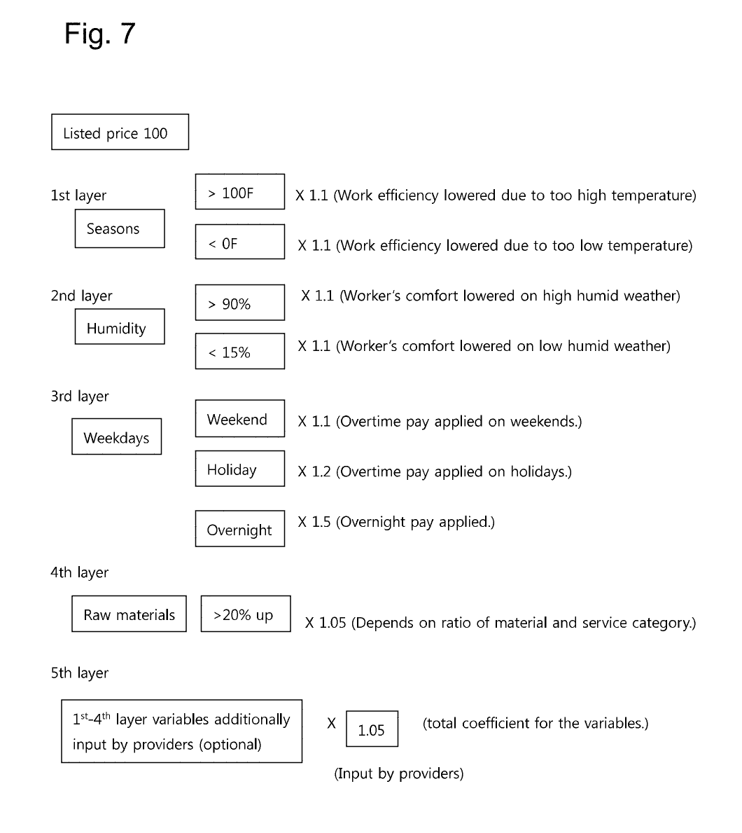

1) This payment holding policy will guarantee the work to be completed 100%
2) If the provider doesn't complete the work, its membership will be suspended from “Cliencom” database and the name will be added to the company black list which appears publicly.
3) If the client doesn't approve the service (f19), “Cliencom” team will contact him by either email or phone and confirm the issue. If no issue is found, the remaining balance will be transferred to the provider.
   FIG. 7 Shows Variables that Affect the 2^{nd} Adjusted Price (about Invention Point 7).
   1^{st}, 2^{nd}, 3^{rd}, 4^{th} layers of the external factors are considered in the price calculation. For example, if the 1^{st} listed price as 100 and have such situation that the temperature is higher than 100 F (1^{st} layer), humidity is above 90% (2^{nd} layer), work needs to be done at night (3^{rd} layer), the material cost has been increased by 20% since 6 months ago (4^{th} layer), “Cliencom” system will calculate the price as below; 100×1.1×1.1×1.5×1.05=190.575 (It changes for each service work. The interior environment where air conditioner is available does not require 1^{st} and 2^{nd} layers)

If the provider adds the 5^{th} layer with 1.05, the 2^{nd} listed price will be calculated as following: 190.575×1.05=200.10375.

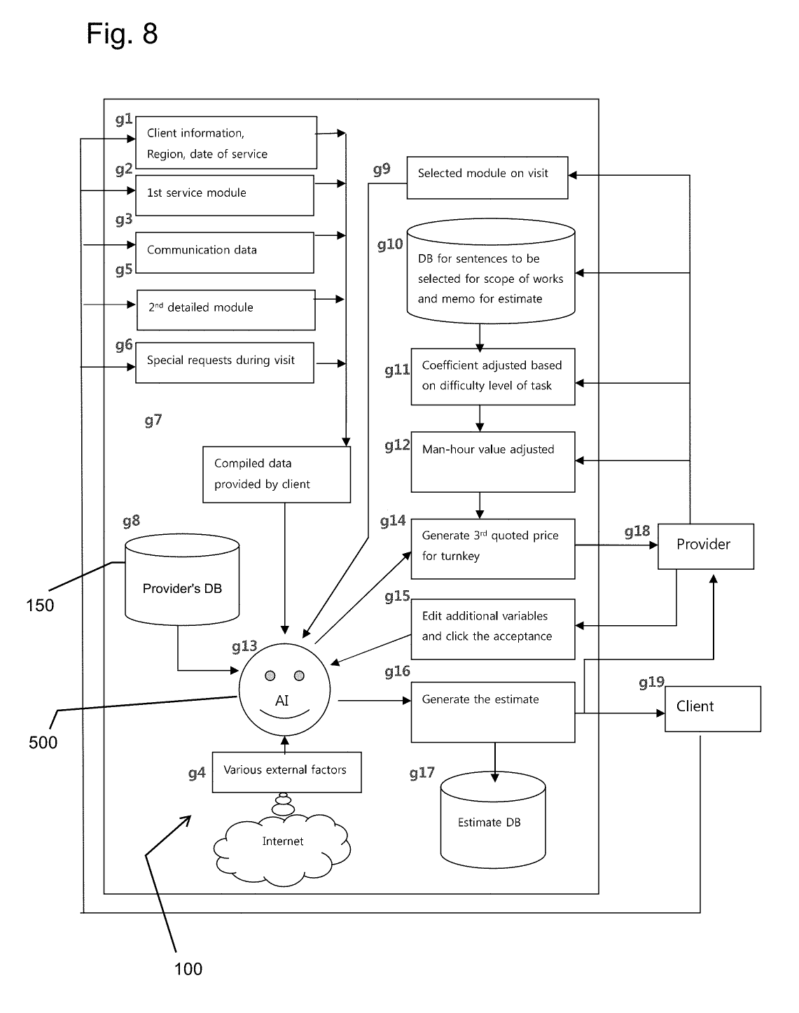

### FIG. 8 Shows Generate 3^{rd} Quoted Price and Estimate.

The 3^{rd} quoted price consists of the following factors:
1) Client information (g1), 1^{st} listed module (g2), communication data (g3), various external factors such as increase of material cost, climate change (g4), 2^{nd} detailed module (g5), special requests during visit (g6), and complied data provided by client (g7)
2) Provider's data base (g8), selected module during visit (g9), DB for sentences to be selected for scope of works and memo for estimate (g10), adjustable coefficient based on difficulty level of task (g11), adjustable man×hour value (g12) Once the 3^{rd} quoted price is calculated through AI system (g13), the estimate will appear.
3) Then, the provider can revise it and click “acceptance” icon (g15) and generate the customized estimate (g16). This estimate will be sent to both provider (g18) and client (g19).

Using this same theory, the customized invoice and contract will be generated and saved under each client and provider's profiles in “Cliencom” data base and sent to both parties.

Please refer to diagram 10 for a sample estimate, and diagram 11 for a sample invoice and contract.

### FIG. 9 Shows 3-Step Price Rule Explanation (Example; Painting Service).

Please see below for details of each page:

### <Page 1> Step 1

<Page 2> Basic module to be selected by a client
<Page 3> Available providers shown on the map
<Page 4> List of the provider sorted by price
<Page 5> Provider's basic parameter for grade rating

### <Page 6> Provider CCC

### <Page 7> Provider AAA

### <Page 8> Provider FFF

### <Page 9> Step 2

<Page 10> 3 selected providers from page 4
<Page 11> Communication tool to speak with 3 selected providers
<Page 12> Detailed module to be selected by a client
<Page 13> Adjusted price list that reflects the added modules in page 12

### <Page 14> Step 3

<Page 15> List of the provider who are ready to perform consultation visit
<Page 16> Tasks to be done during the visit
<Page 17> More detailed modules to be entered by a provider
<Page 18> Final quoted price along with the coefficient of each provider
<Page 19> Price and estimate confirmation and final provider selection
<Page 20> Price comparison in 3 step

### A Sample Chart Version for the Price Comparison.

If the provider inputs prices and coefficient values for each module in FIG. 2 and the client selects the modules in FIG. 3, the system provides a chart for checking a first listed price, a second adjusted price, a third quoted price, and provider's coefficients for the providers CCC, AAA, and FFF as shown in FIG. 9. And, the client can trust the provider grade determined by an AI company grading system and decide easily, receiving lots of help in making a contract for service works.

### REFERENCE

The page that appears to the provider is slightly different. When the client moves the provider to his wish list, the provider will be able to see the module selected by the client along with the provider's pre-set price. The provider will be able to communicate with the client through “Cliencom” messenger and perform the consultation visit once the appointment is made.

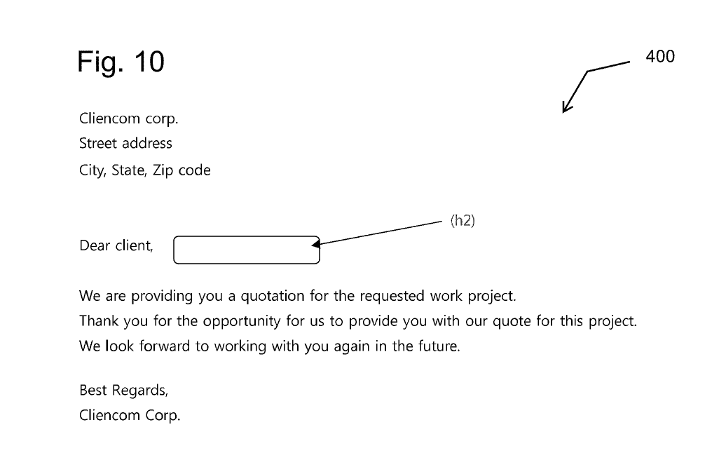

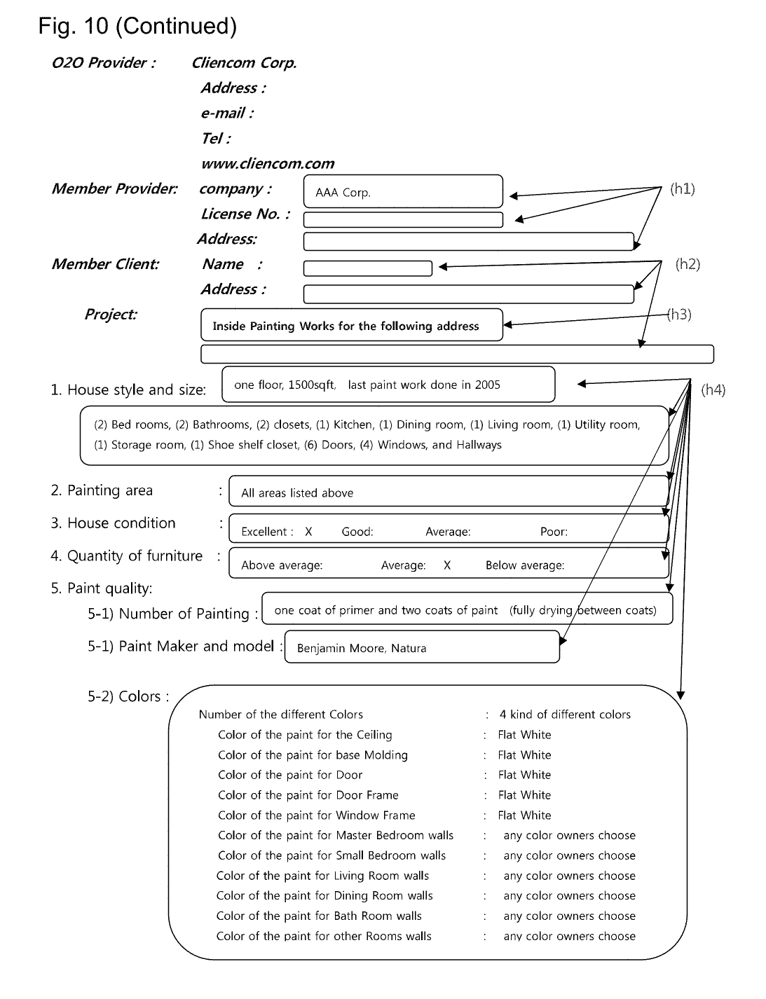

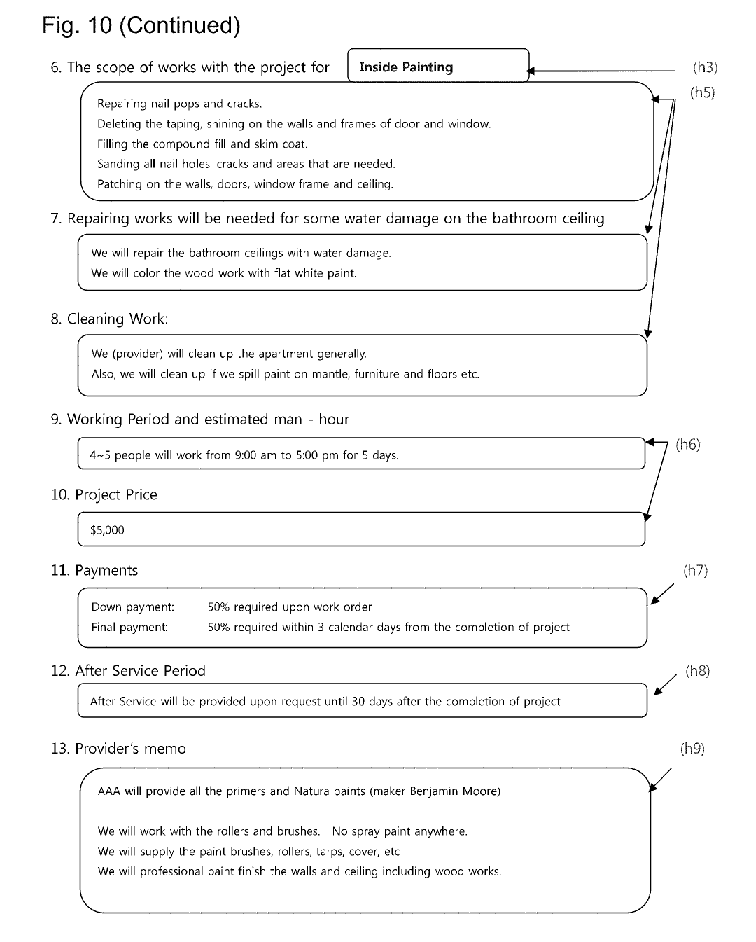

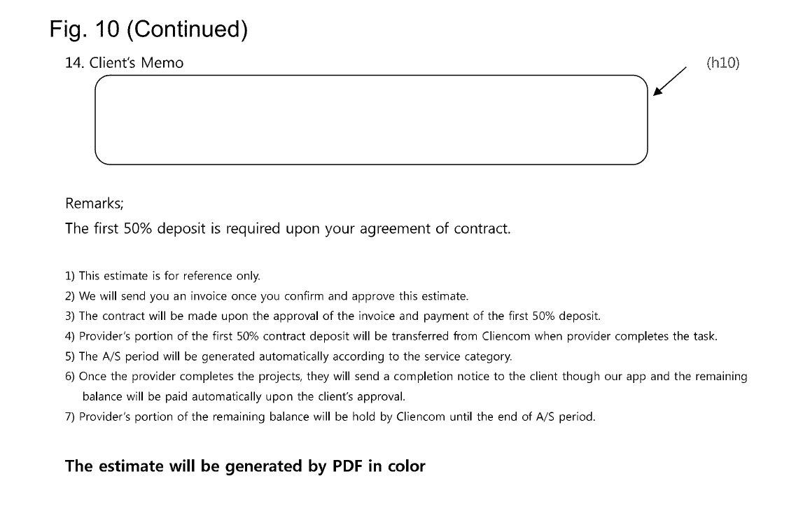

### FIG. 10 Shows a Sample Version of Estimate.

Please see below for the details of the sample estimate:
(h1) Provider information populated from “Cliencom” data base
(h2) Client information populated from “Cliencom” data base
(h3) Project category selected from “Cliencom” data base
(h4) Service related modules selected by client and additional modules selected by the client and provider during the consultation visit.
(h5) Input the detailed work related sentence by provider (Manual mode) or click the preset sentence generated from provider data base (Auto mode).
(h6) Value either manually revised by the provider during the consultation visit or turn-key price calculated by “Cliencom” system with provider's coefficient
(h7) It may differ depends on the service
(h8) It may differ depends on the service module
(h9) Input memo for the estimate by provider or click the preset memo generated from provider data base.
(h10) Client's memo for any comments on the estimate

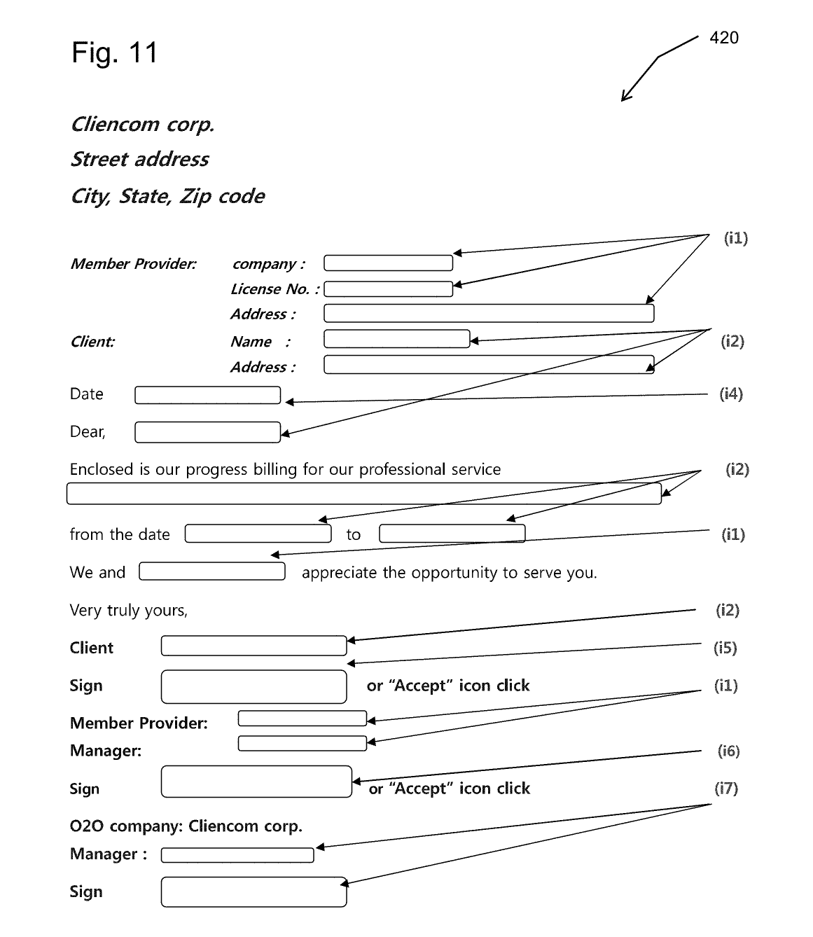

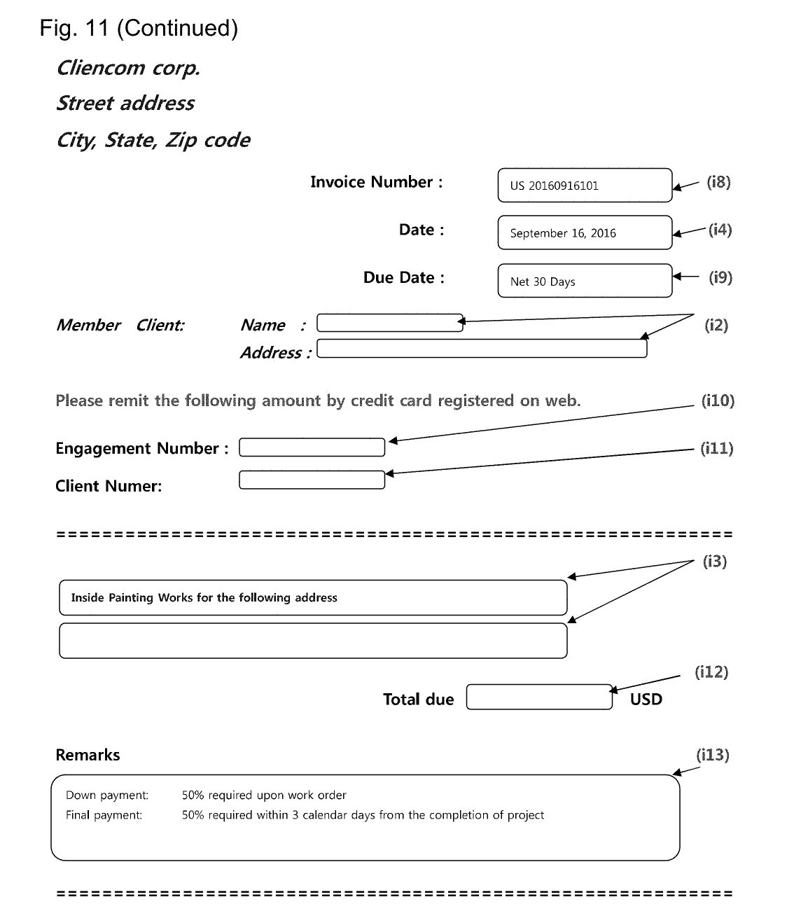

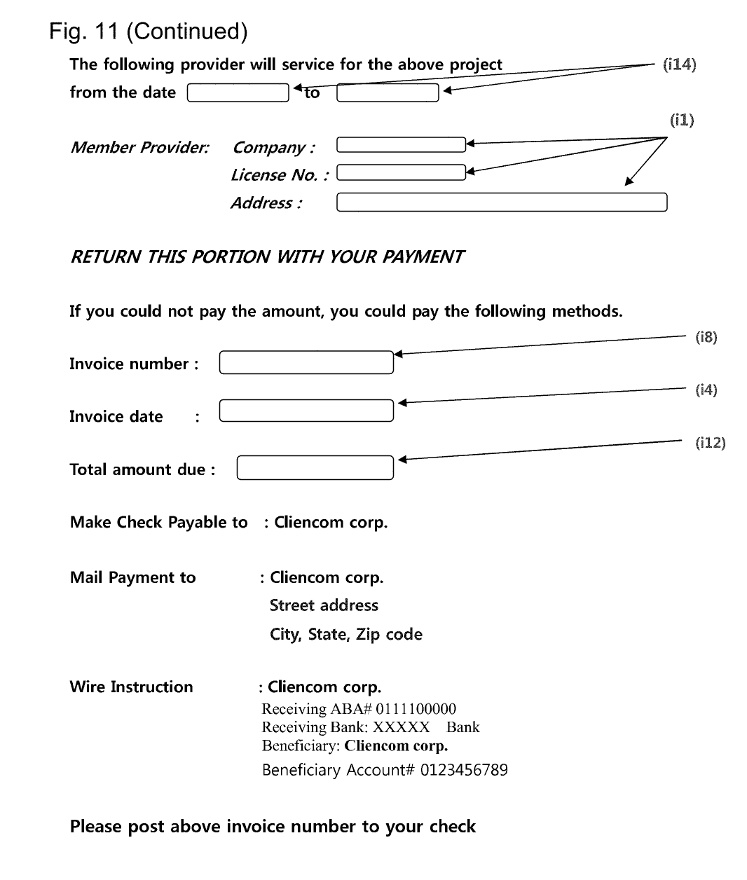

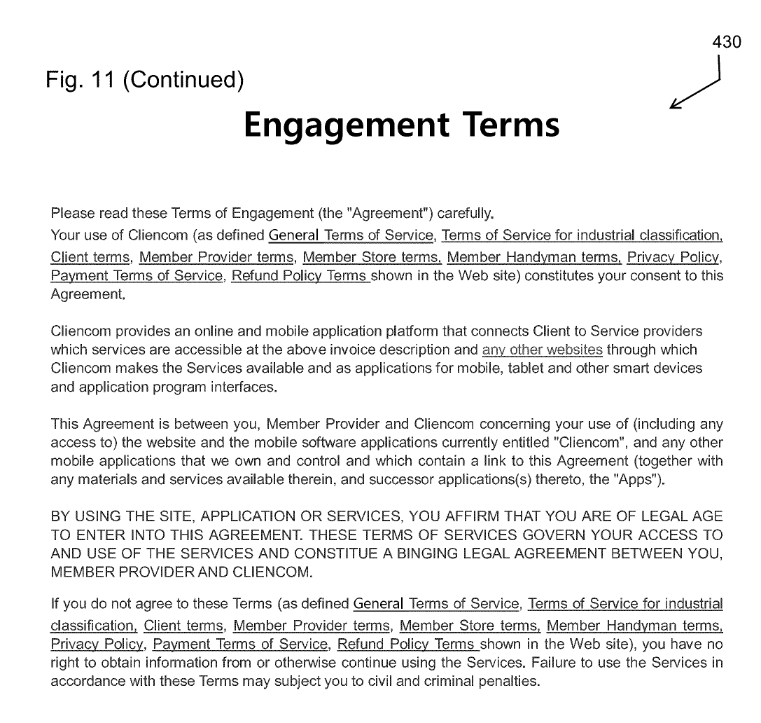

### FIG. 11 Shows a Sample Version of Invoice/Engagement Terms.

This invention targets offline services that cost from hundreds to tens of thousands of dollar. The invoice and engagement terms are populated by PDF.
(i1) Provider information populated from “Cliencom” data base
(i2) Client information populated from “Cliencom” data base
(i3) Project category selected from “Cliencom” data base
(i4) Invoice date generated by “Cliencom” system
(i5) Electronic signature line to be signed by a client
(i6) Electronic signature line to be signed by a provider
(i7) Electronic signature line to be signed by “Cliencom”
(i8) Invoice number populated from “Cliencom” system
(i9) Due date set by “Cliencom” system
(i10) Engagement number set by “Cliencom” app that is uniquely assigned to each project
(i11) Client number set by “Cliencom” system
(i12) Quoted price populated from “Cliencom” system
(i13) Data populated from “Cliencom” system
(i14) Data derived from the client's data base

It is a general term that both engagement terms and invoice are delivered to the client and provider. Also, samples of General Terms of Service, Terms of Service for industrial classification (different for each service category), Client terms, Member Company terms (different for each service category), Member Store terms (different for each service category Member Handyman terms (different for each service category), Privacy Policy, Payment Terms of Service, Refund Policy Terms (different for each service category) that should be included in the engagement term are not listed here as they need to be determined by client, provider, and “Cliencom”.

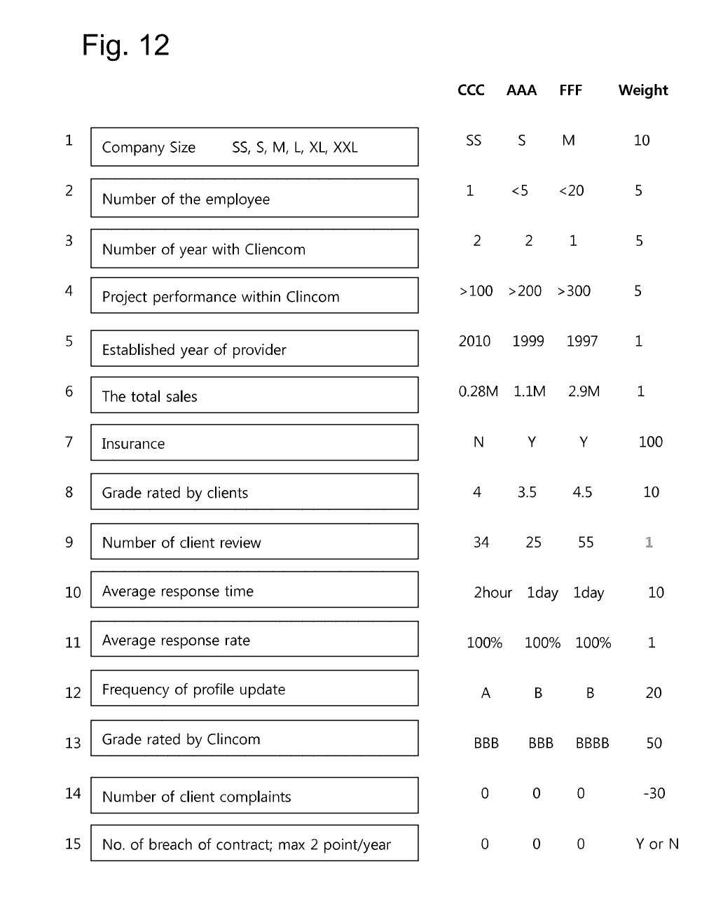

FIG. 12 Shows a Weight Value that is Used to Determine Provider's Grade.
As pages 5, 6, 7, 8 of FIG. 9 demonstrate basic variables that bring the company grade, weight values in FIG. 12 are applied to each variable to calculate the grade.

| | | | Sub- | | | Sub- | | | Sub- | | |
|---|---|---|---|---|---|---|---|---|---|---|---|
| | CCC | Weight | total | AAA | Weight | total | FFF | Weight | total | Descrition | Remarks |
| 1 | 1 | 10 | 10 | 2 | 10 | 20 | 3 | 10 | 30 | Company size | #1 |
| 2 | 1 | 5 | 5 | 2 | 5 | 10 | 4 | 5 | 20 | Employee # | #2 |
| 3 | 2 | 5 | 10 | 2 | 5 | 10 | 1 | 5 | 5 | # of years with | #3 |
| | | | | | | | | | | “Cliencom” | |
| 4 | 10 | 5 | 50 | 11 | 5 | 55 | 12 | 5 | 60 | Project performance | #4 |
| 5 | 6 | 1 | 6 | 17 | 1 | 17 | 19 | 1 | 19 | Established year | #5 |
| 6 | 2 | 1 | 2 | 6 | 1 | 6 | 15 | 1 | 15 | Sales/0.2M | #6 |
| 7 | 0 | 100 | 0 | 1 | 100 | 100 | 1 | 100 | 100 | Insurance | #7 |
| 8 | 4 | 10 | 40 | 3.5 | 10 | 35 | 4.5 | 10 | 45 | Grade rated by client | #8 |
| 9 | 34 | 1 | 34 | 25 | 1 | 25 | 55 | 1 | 55 | # of client review | #9 |
| 10 | 6 | 10 | 60 | 2 | 10 | 20 | 2 | 10 | 20 | Average response time | #10 |
| 11 | 100 | 1 | 100 | 100 | 1 | 100 | 100 | 1 | 100 | Average response rate | #11 |
| 12 | 1 | 20 | 20 | 0.5 | 20 | 10 | 0.5 | 20 | 10 | Frequency of profile | #12 |
| | | | | | | | | | | update | |
| 13 | 5 | 50 | 250 | 5 | 50 | 250 | 6 | 50 | 300 | Grade rated by | #13 |
| | | | | | | | | | | “Cliencom” | |
| 14 | 0 | −30 | 0 | 0 | −30 | 0 | 0 | −30 | 0 | # of client complaints | #14 |
| 15 | 0 | Y or N | 0 | 0 | Y or N | 0 | 0 | Y or N | 0 | # of breach of contract | #15 |
| Total | | | 587 | | | 658 | | | 779 | | |

(CCC 1star)
(AAA 2stars)
(FFF 3stars)

<Grade Rate Vs. Point>

| GRADE | POINT |
|---|---|
| New | <500 point |
| Small 1 star | <550 point |
| 1 star | <600 point |
| 1 + ½ star | <650 point |
| 2 stars | <700 point |
| 2 + ½ star | <750 point |
| 3 stars | <800 point |
| 3 + ½ star | <850 point |
| 4 stars | <900 point |
| 4 + ½ star | <950 point |
| 5 stars | 1000 point |
| 6 stars (special) | >1000 point |
| 7 stars (special) | >1050 point |

“Cliencom” system doesn't allow the new provider to earn more than 500 points and prevents the company from earning high points unreasonably through our scientific calculation method. Also, “Cliencom” will review the quality of the newly provider before “Cliencom” publish them on the app/web so that “Cliencom” can guarantee the quality of the service. Therefore this grade system is reliable and accurate.

For example, if a company named ZZZ that was established in 2009, has 100 employees, 10 M of sales and has a license has registered to “Cliencom” system, this company will get the following points temporarily and posted upon our team's approval. The company named ZZZ will be hidden until the company gets “Cliencom” approval:

### Provider ZZZ

| | | | | Sub- | |
|---|---|---|---|---|---|
| | | ZZZ | Weight | total | |
| 1 | XXL | 6 | 10 | 60 | Company size |
| 2 | 100 | 10 | 5 | 50 | Employee # |
| 3 | 0 | 0 | 5 | 0 | # of years with “Cliencom” |
| 4 | 0 | 0 | 5 | 0 | Project performance |
| 5 | 2000 | 16 | 1 | 16 | Established year |
| 6 | $10M | 50 | 1 | 50 | Sales/0.2M |
| 7 | Yes | 1 | 100 | 100 | Insurance |
| 8 | 0 | 0 | 10 | 0 | Grade rated by client |
| 9 | 0 | 0 | 1 | 0 | # of client review |
| 10 | 0 | 0 | 1 | 0 | Average response time |
| 11 | 0 | 0 | 0 | 0 | Average response rate |
| 12 | 0 | 0 | 20 | 0 | Frequency of profile update |
| 13 | 0 | 0 | 50 | 0 | Grade rated by “Cliencom” |
| 14 | 0 | 0 | −30 | 0 | # of client complaints |
| 15 | 0 | 0 | Y or N | 0 | # of breach of contract |
| | | | | 276 | |

### # Detailed Explanation for Marks

### #1> Company Size Rating

| Size | POINT |
|---|---|
| SS | 1 |
| S | 2 |
| M | 3 |
| L | 4 |
| XL | 5 |
| XXL | 6 |
| XXXL | 7 |

### #2># of Employees Rating

| Full time Employee | POINT |
|---|---|
| Self | 1 |
| <5 | 2 |
| <10 | 3 |
| <20 | 4 |
| <30 | 5 |
| <40 | 6 |
| <50 | 7 |
| <70 | 8 |
| <100 | 9 |
| >100 | 10 |

#3># of Business Years with “Cliencom”
Provider will earn one point per year. The weight value will be different for each service category.

### REFERENCE

The way to show the newly provider on the app/web:
1) When “Cliencom” assigned the company as “a new provider”,
2) The company is received “the company size rating” by “Cliencom”.

### #4> Performance on Our app

| PROJECT | |
|---|---|
| Number | POINT |
| 0 | 0 point |
| <5 | 1 point |
| <10 | 2 point |
| <20 | 3 point |
| <30 | 4 point |
| <40 | 5 point |
| <50 | 7 point |
| <100 | 10 point |
| <200 | 11 point |
| <300 | 12 point |
| <400 | 13 point |
| <500 | 14 point |
| <1000 | 15 point |

Earning each point is very important when the number of project is low. However, once their project numbers increase, this point won't affect points of the company much.

### #5> Established Year

### Current Year—Established Year=?? P

### #6> Sales

### Sales/0.2 M$=?? P

### #7> Insurance

| Insurance | POINT |
|---|---|
| The company has the | 1 |
| insurance | |
| The company has no insurance | 0 |

### #8> Grade Rated by Client

Client review consists of service quality, hospitality, A/S, and price satisfaction.

| Heart | POINT |
|---|---|
| Heart .5 | 0.5 point |
| Heart 1 | 1 point |
| Heart 1.5 | 1.5 point |
| Heart 2 | 2 point |
| Heart 2.5 | 2.5 point |
| Heart 3 | 3 point |
| Heart 3.5 | 3.5 point |
| Heart 4 | 4 point |
| Heart 4.5 | 4.5 point |
| Heart 5 | 5 point |

### #9> Number of Client Review

Number of clients who leave the review.

### #10> Average Response Time

| Average Response time | POINT |
|---|---|
| within 10 minutes | 10 point |
| within 30 minutes | 9 point |
| within 45 minutes | 8 point |
| within 60 minutes | 7 point |
| within 120 minutes | 6 point |
| within 180 minutes | 5 point |
| within 240 minutes | 4 point |
| within 360 minutes | 3 point |
| within 24 hours | 2 point |
| within 48 hours | 1 point |
| after 48 hours | 0 point |

### #11> Response Rate %=Point

Response rate is an average rate
If the response rate is low during the early business years with “Cliencom” app, it will be difficult to increase the points later on.

### #12> Frequency of Profile Update

“Cliencom” system will monitor how frequent the provider updates the profile to keep their information up to date and grade them.

| Grade | Point | Comment |
|---|---|---|
| A | 1 point | Frequent (more than once a month) |
| B | 0.5 point | Moderate (more than once every 3 months) |
| C | 0 point | Inactive (no update since registration) |

### #13> Grade Rated by “Cliencom”

“Cliencom” team will either visit the provider randomly or send messages as if “Cliencom” supervisors are the clients and evaluate their service quality. Their technical skills, client service, accuracy, response speed and rate, company size and interior level, office or store environment will be considered as grading factors.

| GRADE | POINT |
|---|---|
| AAAA | 10 point |
| AAA | 9 point |
| AA | 8 point |
| A | 7 point |
| BBBB | 6 point |
| BBB | 5 point |
| BB | 4 point |
| B | 3 point |
| CCCC | 2 point |
| CCC | 1 point |
| C | 0 point |

### #14> Number of Client Complaints

| # of Complaint/Year | − POINT |
|---|---|
| 0 | 0 point |
| 1 | −1 point |
| 2 | −2 point |
| 3 | −3 point |
| 4 | −4 point |
| 5 | −5 point |
| 6 | −6 point |
| 7 | −7 point |
| 8 | −8 point |
| 9 | −9 point |

If the provider receives 3 complaint points, the weight value of 30 (it may differ per service category) will be applied so that its grade will be automatically decreased.

If its points drop below 500 points, its name will not be shown to the clients on “Cliencom” app. Therefore, this system triggers the provider to provide the best service.

If the provider replies to the client's complaints with sincere apology or reasonable sentences, “Cliencom” will not reduce the points upon “Cliencom” decision. Also, this section is restricted to the clients who received the actual service. Therefore, it prevents the intentional and malignant comments.

Furthermore, “Cliencom” app/web will have a special event once a year that deletes all the client reviews of the providers that received less than 3 hearts so that they can regain the client trust freshly.

### #15># of Breach of Contract

| # of breach of | |
|---|---|
| contract | Comment |
| Once a year | # of - Points will be determined by “Cliencom” |
| | after speaking with the client (−10p~−300p) |
| Twice a year | The provider will be suspended from “Cliencom” |
| | and may be allowed to re-re-register next year |

### REFERENCE

Different weight value and point system will be applied for each service category so that the providers in the same category can be compared for their services. “Cliencom” algorithm is a fair aggregator because of the company grade statistically, scientifically, and systematically so that even a new provider receives a fair grade.

### Auto Generating Function of the Estimate Sentences

The previously entered the scope of work's description (see below) will be saved to the provider's own data base and will be shown on its window so that the provider can choose the sentence from the drop-down list. For example, if the provider clicks #2, it will bring the sentences to the estimate (FIG. 10).

| Check | Description | Coefficient |
|---|---|---|
| 1 | Repairing works will be needed door damage. | X 1.02 |
| | Door hinge will be changed. | |
| | One door will be needed wood works. | |
| 2 v | Repairing works will be needed some water | X 1.1 |
| | damage on the bathroom ceiling. | |
| | Repairing bathroom ceilings with water damage. | |
| | Coloring for the wood work with flat white paint. | |
| 3 | Repairing works will be needed window damage. | X 1.03 |
| | Window rail will be changed. | |
| | New grass will be installed on one window. | |
| 4 | Make the one storage wall. | X 1.05 |
| | One door will be installed. | |
| | Wood work will be needed. | |
| 5 | Repairing works will be needed one side of the | X 1.04 |
| | wall damaged. | |
| | Wood work will be needed.. | |
| | Coloring for the wood work with flat white paint. | |

### Auto Generating Function of the Estimate Memo

The previously entered memo description (see below) will be saved to the provider's own data base and will be shown on its window so that the provider can choose the memo line from the drop-down list. For example, if the provider clicks #1, 3, 5, 7 from the list, it will create memo sentences in the estimate (FIG. 10).

Therefore, upon the negotiation with the client, the provider will be able to establish the final estimate.

| Check | Description | Coefficient |
|---|---|---|
| 1 v | AAA will provide all the primers and Natural | X 1.0 |
| | paints (maker Benjamin Moore) | |
| 2 | AAA will provide the repairing works for | X 1.1 |
| | bathroom wall tail. | |
| 3 v | We will work with the rollers and brushes. No | X 1.0 |
| | spray paint anywhere. | |
| 4 | We will work the exchanging works for door | X 1.01 |
| | locks | |
| 5 v | We will supply the paint brushes, rollers, tarps, | X 1.0 |
| | cover, etc | |
| 6 | We will work the molding wood works at the | X 1.05 |
| | dinning wall and hall way. | |
| 7 v | We will professional paint finish the walls and | X 1.1 |
| | ceiling including wood works. | |
| 8 | We will change new AC outlet on the wall | X 1.01 |
| 9 | We will paint with waterproof works | X 1.1 |
| 10 | We will paint with heat resistance epoxy resin. | X 1.07 |

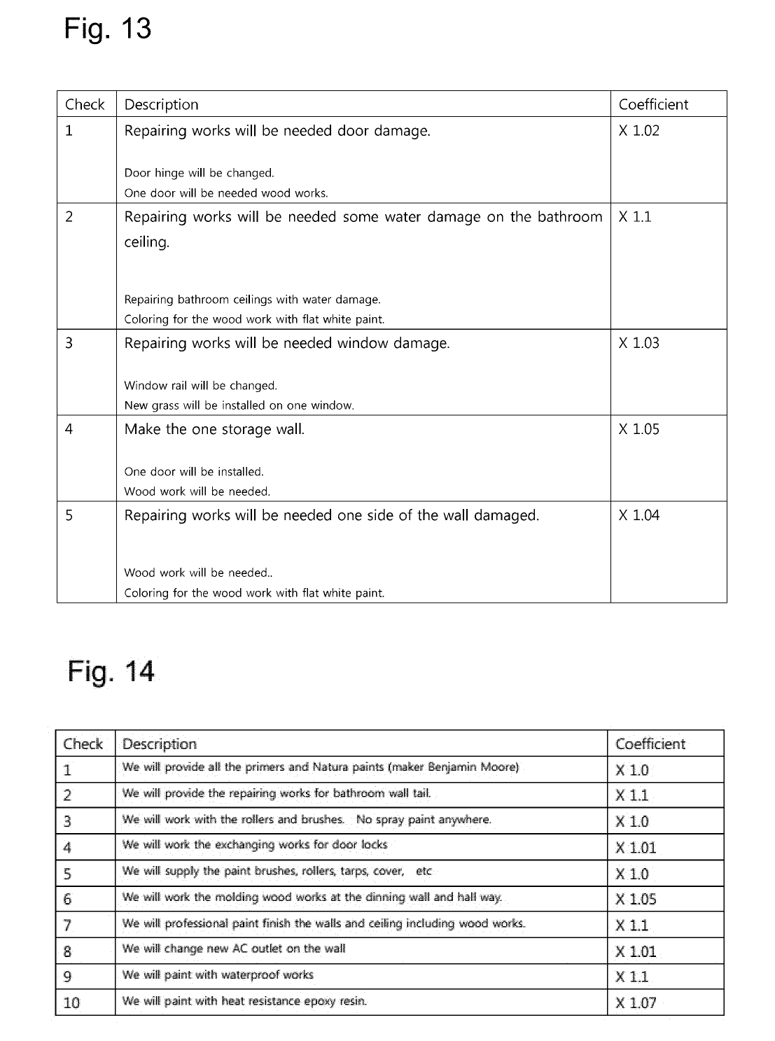

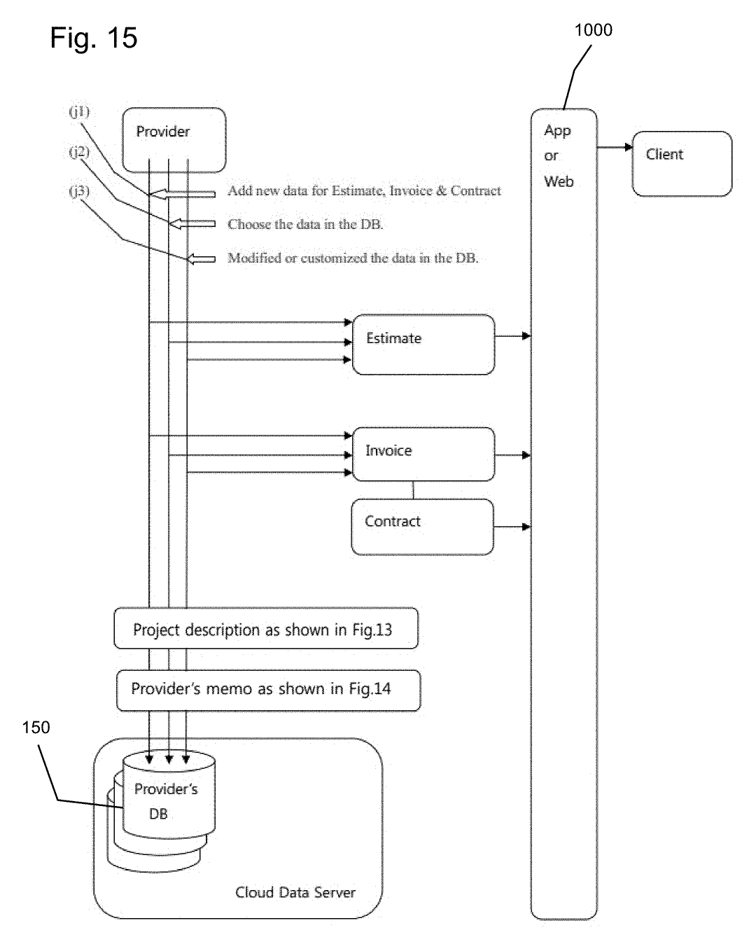

FIG. 13 Shows a Sample of Painting Service DB's Field for Project Description According to an Embodiment of the Invention, and FIG. 14 Shows a Sample of Painting Service DB's Field for Provider's Memo According to an Embodiment of the Invention.

The AI system organizes by the service category and learns sentences related to the project description and memo to be outputted to the estimate (contract) according to the service areas. Based on these, the provider inputs the sentences related to the service work and description or memo to the provider's own DB, and the number of using the sentence in the estimate (contract) is kept in record.

If building many DBs and using them frequently, the AI system recognizes the provider as a knowledgeable company, imparting a high point.

The AI system determines the provider to be a little knowledgeable company, giving a low point if a provider inputting a few descriptions and memo and using them rarely in producing the estimate (contract).

If they don't input description or memo or input sentences that are not related to the service work and sentences that they do not use in producing the estimate (contract) actually in the DB, the AI system may not give any point.

FIG. 13 shows a sample of painting service DB's field for project description, and FIG. 14 shows a sample of painting service DB's field for provider's memo.

And, in the case of inputting in foreign language, an additional point may be given if the contents that are translated by a translator are suitable to the service.

FIG. 15 Shows the Data Flow of the Description and Memo with Provider DB

There is three ways to use own DB data by providers to create and deliver the estimates, invoices, and contracts with the cloud data processing.

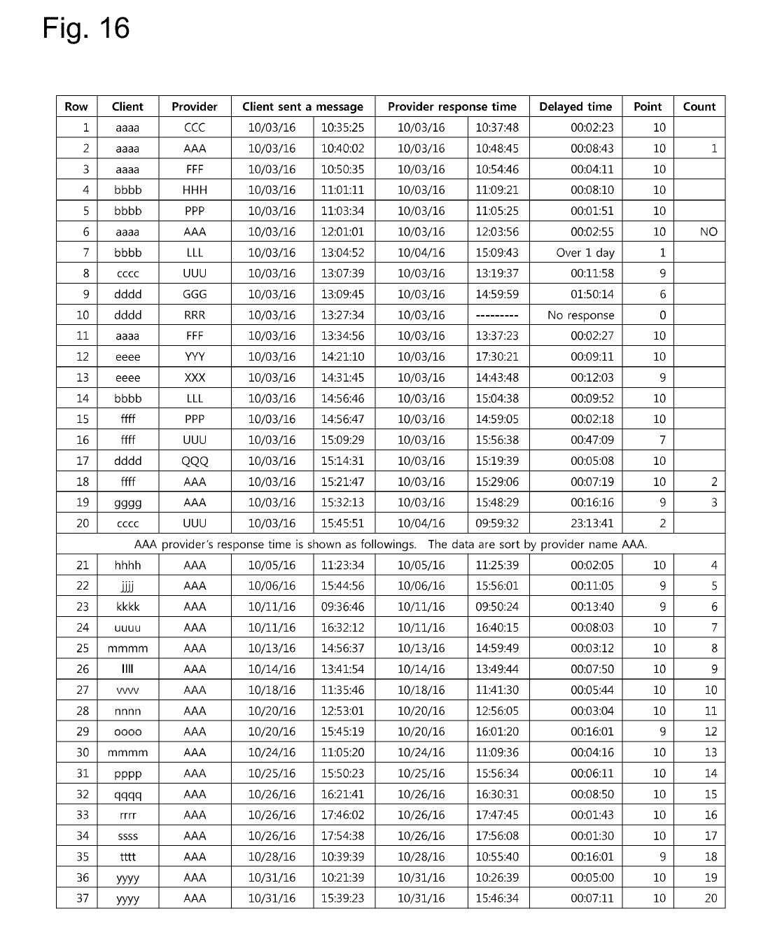

(j1) Add new data;
The data flow to add some of the words, clauses, sentences and expressions for the memo and description column in the provider's database.
(j2) Choose the data;
The data flow to choose some of the words, clauses, sentences and expressions for the memo and description column in the provider's database.
(j3) Modify the data
The data flow to modify some of the words, clauses, sentences and expressions for the memo and description column in the provider's database.
FIG. 16 Shows how an AI System Decides the Point with AAA's Response Time.

The rows 1˜20 are examples of response time data of various providers to text inquiries of clients, and the rows 21˜37 are sorted dada for the provider AAA only, which are an example of base data for statistical analysis of the response time of AAA.

Since the provider needs time to respond to inquiries from a same client or requiring some time to respond, such request within two hours may not be included. For an example, the client aaaa among clients inquiring to the provider AAA requested within two hours as shown in the rows 2 and 6, those requests are not included in statistics and the count column, row 6, records as NO. The client mmmm requested on Oct. 31, 2016 in the row 25 and on Oct. 24, 2016 in the row 30, being included in the statistics, and the client yyyy requested with an interval of two hours in the rows 36 and 37 and included in the statistics. With the rules as in the above, the point for 20 clients of the provider AAA with respect to communication exchanged response time can be calculated below, where the value 9.75 is obtained for the company grading by (10*15+9*5)/20=9.75.

### Some Functions of the AI System

1) The AI system according to an embodiment of the invention automatically generates a warning message to the O2O business model system, and the O2O business model system audits the provider to determine fraudulent activity if the provider's sales amount increases unrealistically from the previous year compared to the average growth rate of the local market.
2) When the price range of various service modules has been inputted, if the provider inputs a price that is higher or lower than the price range, the AI system can send a warning message to Cliencom. Then, Cliencom may contact the provider and guide and help the provider to input a reasonable price.

3) Since the O2O business according to an embodiment of the invention manages various types of business, and therefore the contract terms may be different according to the types of services, Clientcom system may rearrange the contract terms according to the types of services.

4) The AI system has the function to display the A/S period and contract terms for the various service tasks to the client under Cliencom approval.

Referring to the figures, the embodiments of the invention are described in detail.

An aspect of the invention provides an O2O business model system for marketing services between a plurality of providers (10) and a client (20) in a computer network having a server (100) and a plurality of terminals (200) as described below as shown in FIG. 1, the block diagram, and FIGS. 2-16. FIG. 1-1 shows modules for generating the price, and FIG. 1-2 shows a Kitchen Remodeling photo sample for 1^{st} List Price.

Especially as shown in FIGS. 6 and 8, the O2O business model comprises steps for:

each of the plurality of providers's registering as a member at the server (100) and inputting a plurality of prices for layered service modules (120) categorized according to kinds of services to provide and a plurality of coefficient values for calculating prices, as shown in FIG. 2;

the client's selecting a single service, selecting first layers (122) of corresponding layered service modules (120), and selecting a group of providers out of the plurality of providers suggested according to the client's selecting of the single service and the first layers (122), as shown in FIG. 2;

the server's providing information and a listed price of each of the selected group of providers (10) in response to the client's selecting, as shown in FIGS. 1˜3, 6, and 8;

the client's communicating via a limited messenger (300) with the preferred or selected group of service providers (30), which are chosen based on the listed price, and selecting second layers (124) of detailed service module of the corresponding layered service modules (120) that are more detailed than the first layers (122) of the preferred or selected group of service providers in order to redefine the service, as shown in FIG. 5;

the server's providing an adjusted price of each of the selected group of providers (30) in response to the client's selecting the second layers (124) of detailed service module, as shown in FIGS. 1˜3, 6, and 8;

the client (20) and each of the selected group (30) of providers's discussing and agreeing on parameters (a variety of variables for the service task) including sentences and memos to be included in the estimate (400) and invoice (420) for determining, upon agreement between the client (20) and each of the selected group of providers (30), which are chosen based on the adjusted price, a selection of preset detailed coefficient values for the server (100) to use in providing a quoted price of each of the selected group of providers (30) to the client (20), wherein the preset detailed coefficient values are selected for providing the quoted price to the client (20) and the selected group of providers (30), and the server (100) produces the estimate using newly written sentences and memos or the selected sentences and memos that inputted and registered in the server (100) in advance, as shown in FIGS. 13˜15;

the client's comparing and choosing service from the plurality of providers (10) based on the listed price, the adjusted price, and the quoted price along with a company profile, a grading rate assigned by an AI system (500), words and sentences presented by the server (100) based on previous client's evaluations of each of the providers (10) so that the client (20) refers to the presented words and sentences, degree of kindness of staffs, degree of satisfaction of customized service, technology level, further sentences and memos for details of the service to be included in the estimate (400), difference in prices, and deciding whether all information used to obtain the listed price, the adjusted price, and the quoted price are reasonable, as shown in FIG. 9; and

the server's generating an estimate (400), an invoice (420), and a contract (420), wherein the estimate (400) is generated on completion of memos related to the service modules (120) that the client (20) and the service provider (30) selected together and the selection of detailed service and values of corresponding coefficients, as shown in FIGS. 10 and 11.

The O2O business model system may further comprise a step in which each of the service providers inputs module prices for three layers (122, 124, 126) of detailed service module of the corresponding layered service modules (120) in order to redefine the service in advance, so that the client (20) selects some of the first, second, and third layers (122, 124, 126) of detailed service modules (120) in a desired step for the listed price, the adjusted price, or the quoted price, as shown in FIGS. 2 and 3.

In certain embodiments of the invention, the first, second, and third layers (122, 124, 126) of the layered service modules (120) can be presented to the client (20) or the providers (10) as 1^{st}, 2^{nd} and 3^{rd} Step of the method, so that the complexity of layered module structure, a sort of internal structure, may be hidden to them, and easier and more conceptual structure of serial steps be presented to them. In any cases, the core concepts of the inventive features are same, but it may be adapted to situation of usage of the invention. Therefore, it may be about naming of parts of the invention.

The selecting the group of providers (30) in order to calculating the adjusted price may be based on the listed price, along with a company profile, a grading rate assigned by an AI system (500), and difference in prices that the client (20) reviews, and then the client (20) selects the second layers (124) of service modules (120) that are in more detail than the first layers (122) of service modules (120).

The layered service module may comprise a graphic module providing with service-related pictures for helping the client (20) in selecting one or more providers (10) as shown in FIGS. 1-2. This graphic module may be applied to the other steps to add further details to the steps, or prior or posterior to the specific step, if necessary.

The limited messenger function may be provided, in which the client (20) is enabled to exchange text messages, images, voice communication with the selected group of providers (30) in the wish list (110) while the corresponding selected providers (30) are in the wish list (110), as shown in FIG. 9, Page 10.

The said step for the client (20) and each of the selected group (30) of providers's discussing, determining, and inputting further comprises a step for the client (20) or one of the selected group (30) of providers's visiting a venue related to the selected service and selecting detailed modules or coefficient values, and the visiting of the venue is arranged through the enabled exchanging of text messages, voice communication between the client (20) and the one of the selected group of providers (30).

The limited messenger function between the provider (30) and the client (20) may be deactivated when the provider (30) is removed from the wish list (110) or an event between the provider (30) and the client (20) is over.

The O2O business model system may further comprise a step for creating one or more sub-modules (130) by the group of providers (10) upon the system's approving a corresponding request for the one or more sub-modules (130) by the group of providers (10). And the first layers or the second layers (122, 124) of detailed service module may comprise sub-layers (130) for further details, which are added of defined by the client (20), the provider (10), or the client (20) and the provider (10) for defining details of the service, as shown in FIGS. 4-1, 4-2, and 4-3. This further step may be inserted in any of the other steps to add further details to the steps.

The step for the server's providing of the adjusted price may comprise a step for analyzing conditions or big data including season, peak time, schedule, time of the day, price of material, and weather.

The O2O business model system may further comprise steps for: the system's generating and providing an estimate (400) based on the quoted price to the client (20) logged in the server (100); the server's generating and providing the invoice (420) and contract (430) automatically when the client (20) approves the estimate (400); and a step for automatically generating a contract (420) between the client (20) and a website (1000) for the O2O business model system, wherein contents of the contract (430) are determined by the AI system (500) according to the service types, as shown in FIGS. 10 and 11.

In the step for the system's generating and providing an estimate (400), at least a portion of words, clauses, sentences, and expressions for a memo column of the estimate may be selected from a database (150) created and maintained by the one of the selected group of providers (30) and added to a predetermined default estimate. Each of the selected group of providers (30) may be given with samples of the words, clauses, sentences, and expressions to choose from by the corresponding provider from its own DB, the provider's DB (150), and the samples of the words, clauses, sentences, and expressions may be customized to each of the selected group of providers (30) and stored in a database (150) for each of the selected group of providers (30), as shown in FIGS. 13˜15.

The O2O business model system may further comprise a step for summarizing and showing the listed price, the adjusted price, and the quoted price along with the plurality of coefficient values and the detailed coefficient values of the one of the selected group of providers (30).

The O2O business model system may further comprise a step for using the AI system (500) and determining the grading rate for one of the plurality of providers using a company profile, as shown in FIGS. 12 and 16.

The company profile may comprise size of company, store interior design, number of employee, number of years with the O2O business model system, number of projects, year of establishment, total sales, insurance, certificate, license, client reviews rate, number of reviewers, response time upon clients' request, response rate, activity rate on the O2O business model system, provider grade by O2O business model system, number of dissatisfaction received from clients (20), and number of breach of contract.

The three layers (122, 124, 126) of detailed service module may include items comprising selecting service area, service work, service amount, service size, service kind, and man-hour, enabling the service providers (10) to quantify the items and input or adjust the prices at a specific step.

In the above embodiment of the invention, the O2O business model system may further comprise a step for the preferred or selected group of service providers (30) and selecting third layers (126) of detailed service module of the corresponding layered service modules (120) that are more detailed than the first and second layers (122, 124) of the preferred or selected group of service providers (30) in order to redefine the service.

Another aspect of according to another embodiment of the invention provides a price comparison service method for O2O business model between a plurality of providers (10) and a client (20) in a computer network having a server (100) and a plurality of terminals (200), as shown in FIG. 1, the block diagram.

The method comprises steps for:

inputting a plurality of prices for layered service modules (120) associated with corresponding images and texts related to the service by each of the plurality of providers (10);

selecting first layers (122) of a corresponding layered service modules (120) by the client (20);

once the client (20) selects preferred service providers (10) and a first layer (122) of service modules, the server's providing a listed price by summarizing module prices that each of a predetermined number of providers (10) provides in advance, that the server (100) prepared in advance, so that the client (20) compares the listed price;

selecting second layers (124) of detailed service module of the corresponding layered service modules (120) that are more detailed than the first layers (122) by the client (20);

if the client (20) communicates with the preferred service provider (30) through a messenger (300) and selects the second layers (124) of service modules, the server's providing a adjusted price for each of the predetermined number of providers (30) by summarizing modules and prices that the server (100) prepared in advance;

the client (20) and each of the one or more selected providers's discussing and agreeing on parameters (a variety of variables for the service task) for determining use of preset detailed coefficient values that the server uses to calculate, after the client (20) meets the predetermined number of providers (30) in a venue for providing the service and each of the predetermined number of providers (30) selects the kinds of final work and memos in the database, so as to provide a quoted price of each of the predetermined number of providers (30) to the client (20) by adjusting the preset detailed coefficient values and making a decision; and

summarizing and showing a combination of the listed price, the adjusted price, and the quoted price along with the plurality of coefficient values and the detailed coefficient values of the predetermined number of providers (30) in terms of table, graph, or chart by the server (100).

Still another aspect of the invention provides a company-grading method for O2O business model between a plurality of providers (10) and a client (20) in a computer network having a server (100) and a plurality of terminals (200).

The method comprising a step for determining the grading rate for one of the plurality of providers (10) using a company information using an AI system (500), and the company profile comprises size of company, store interior design, number of employee, number of years with the O2O business model system, number of projects, year of establishment, the total sales, insurance, certificate, license, client reviews rate, number of reviewers, response time upon client's requests, response rate, activity rate on the O2O business model system, provider grade by O2O business model system, number of dissatisfaction received from clients, and number of breach of contract.

And the AI system (500) generates the grade of the providers (10) every quarter through an algorithm along with the response time data collected through the server (100), wherein the server (100) collects data from the communication exchanged between providers (10) and their potential clients (20), wherein this communication response time measures the time interval that occurs between the initial request sent by clients (20) and the first response sent by the provider (10).

And the AI system (500) analyzes and processes technical sentence and memo inputted to a provider's database (150) for the unique estimate (400) and invoice (420) by the providers (10) with a machine-learning technique, so as to calculate point values for company-grading. The AI system (500) measures frequency of using of technical sentences and gives points according to suitability and the frequency of the technical sentences, and the provider (10) stores a plurality of unique technical sentences and expressions in the provider's database (150), so as to be used by the AI system (500) in generating the grade.

The AI system (500) provides a plurality of environment coefficients for the adjusted price with the analyzing conditions or big data including various external factors obtained from Internet comprising season, peak time, schedule, time of the day, price of material, and weather.

The AI system (500) uses different applications for different variables, elements, and contract terms, based on the service types, and the contract terms are selected so as to fit to corresponding service types and to be agreeable to the client (20) and the provider (10).

The AI system (500) may automatically generate a warning message to the O2O business model system, and the O2O business model system audits the provider (10) to determine fraudulent activity if the provider's total sales increases unrealistically from the previous year compared to the average growth rate of the local market.

The AI system (500) may use one of the data for generating the provider's grade generating that the provider (10) stores the unique technical sentence and memo to a provider's database (150) for the estimate (400) and invoice (420) quality. Each of the service providers (10) may store proper technical sentences and memos related to the service. The AI system (500) may learns sentences related to the service and grades the level of sentences that the service provider (10) inputs, and measure quantity of technical sentences and memos and frequency of using the technical sentences and memos in the estimate that the service provider (10) submits to the client (20).

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An O2O business model system for marketing services between a plurality of providers and a client in a computer network having a server and a plurality of terminals, the O2O business model comprising steps for:
each of the plurality of providers's registering as a member at the server and inputting a plurality of prices for layered service modules categorized according to kinds of services to provide and a plurality of coefficient values for calculating prices;
the client's selecting a single service, selecting first layers of corresponding layered service modules, and selecting a group of providers out of the plurality of providers suggested according to the client's selecting of the single service and the first layers;
the server's providing information and a listed price of each of the selected group of providers in response to the client's selecting;
the client's communicating via a limited messenger with the preferred or selected group of service providers, which are chosen based on the listed price, and selecting second layers of detailed service module of the corresponding layered service modules that are more detailed than the first layers of the preferred or selected group of service providers in order to redefine the service;
the server's providing a adjusted price of each of the selected group of providers in response to the client's selecting the second layers of detailed service module;
the client and each of the selected group of providers's discussing and agreeing on parameters (a variety of variables for the service task) including sentences and memos to be included in the estimate and invoice for determining, upon agreement between the client and each of the selected group of providers, which are chosen based on the adjusted price, a selection of preset detailed coefficient values that the server uses in providing a quoted price of each of the selected group of providers to the client, wherein the preset detailed coefficient values are selected for providing the quoted price to the client and the selected group of providers, and the server produces the estimate using newly written sentences and memos or the selected sentences and memos that inputted and registered in the server in advance;
the client's comparing and choosing service from the plurality of providers based on the listed price, the adjusted price, and the quoted price along with a company profile, a grading rate assigned by an AI system, words and sentences presented by the server based on previous client's evaluations of each of the providers so that the client refers to the presented words and sentences, degree of kindness of staffs, degree of satisfaction of customized service, technology level, further sentences and memos for details of the service to be included in the estimate, difference in prices, and deciding whether all information used to obtain the listed price, the adjusted price, and the quoted price are reasonable; and
the server's generating an estimate, an invoice, and a contract, wherein the estimate is generated on completion of memos related to the service modules that the client and the service provider selected together and the selection of detailed service and values of corresponding coefficients.

2. The O2O business model system of claim 1, further comprising a step in which each of the service providers inputs module prices for three layers of detailed service module of the corresponding layered service modules in order to redefine the service in advance, so that the client selects some of the first, second, and third layers of detailed service modules in a desired step for the listed price, the adjusted price, or the quoted price.

3. The O2O business model system of claim 1, wherein the selecting the group of providers in order to calculating the adjusted price is based on the listed price, along with a company profile, a grading rate assigned by an AI system, and difference in prices that the client reviews, and then the client selects the second layers of service modules that are in more detail than the first layers of service modules.

4. The O2O business model system of claim 1, wherein the layered service module comprises a graphic module providing with service-related pictures for helping the client in selecting one or more providers.

5. The O2O business model system of claim 1, wherein the limited messenger function is provided, in which the client is enabled to exchange text messages, images, voice communication with the selected group of providers in the wish list while the corresponding selected providers are in the wish list,
wherein the said step for the client and each of the selected group of providers's discussing, determining, and inputting further comprises a step for the client or one of the selected group of providers's visiting a venue related to the selected service and selecting detailed modules or coefficient values, wherein the visiting of the venue is arranged through the enabled exchanging of text messages, voice communication between the client and the one of the selected group of providers, and
wherein the limited messenger function between the provider and the client is deactivated when the provider is removed from the wish list or an event between the provider and the client is over.

6. The O2O business model system of claim 1, further comprising a step for creating one or more sub-modules by the group of providers upon the system's approving a corresponding request for the one or more sub-modules by the group of providers,
wherein the first layers or the second layers detailed service module comprise sub-layers for further details, which are added of defined by the client, the provider, or the client and provider for defining details of the service.

7. The O2O business model system of claim 1, wherein the step for the server's providing of the adjusted price comprises a step for analyzing conditions or big data including season, peak time, schedule, time of the day, price of material, and weather.

8. The O2O business model system of claim 1, further comprising steps for:
the system's generating and providing an estimate based on the quoted price to the client logged in the server;
the server's generating and providing the invoice and the contract automatically when the client approves the estimate; and
a step for automatically generating a contract between the client and a website for the O2O business model system, wherein contents of the contract are determined by the AI system according to the service types.

9. The O2O business model system of claim 8, wherein in the step for the system's generating and providing an estimate, at least a portion of words, clauses, sentences, and expressions for a memo column of the estimate are selected from a database created and maintained by the one of the selected group of providers and added to a predetermined default estimate, wherein each of the selected group of providers is given with samples of the words, clauses, sentences, and expressions to choose from by the corresponding provider from its own DB, and wherein the samples of the words, clauses, sentences, and expressions are customized to each of the selected group of providers and stored in a database for each of the selected group of providers.

10. The O2O business model system of claim 8, further comprising a step for summarizing and showing the listed price, the adjusted price, and the quoted price along with the plurality of coefficient values and the detailed coefficient values of the one of the selected group of providers.

11. The O2O business model system of claim 1, further comprising a step for using the AI system and determining the grading rate for one of the plurality of providers using a company profile, wherein the company profile comprises size of company, store interior design, number of employee, number of years with the O2O business model system, number of projects, year of establishment, total sales, insurance, certificate, license, client reviews rate, number of reviewers, response time upon clients' request, response rate, activity rate on the O2O business model system, provider grade by O2O business model system, number of dissatisfaction received from clients, and number of breach of contract.

12. The O2O business model system of claim 11, wherein the AI system generates the grade of the providers every quarter through an algorithm along with the response time data collected through the server, wherein the server collects data from the communication exchanged between providers and their potential clients, wherein this communication response time measures the time interval that occurs between the initial request sent by clients and the first response sent by the provider.

13. The O2O business model system of claim 11, wherein the AI system uses one of the data for generating the provider's grade that the provider stores the unique technical sentence and memo to a provider's database for the estimate and invoice quality, wherein each of the service providers stores proper technical sentences and memos related to the service, wherein the AI system learns sentences related to the service and grades the level of sentences that the service provider inputs, and measures quantity of technical sentences and memos and frequency of using the technical sentences and memos in the estimate that the service provider submits to the client.

14. The O2O business model system of claim 1, wherein the three layers of detailed service module includes items comprising selecting service area, service work, service amount, service size, service kind, and man-hour, enabling the service providers to quantify the items and input or adjust the prices at a specific step.

15. A price comparison service method for O2O business model between a plurality of providers and a client in a computer network having a server and a plurality of terminals, the method comprising steps for:
inputting a plurality of prices for layered service modules associated with corresponding images and texts related to the service by each of the plurality of providers;
selecting first layers of a corresponding layered service modules by the client;
once the client selects preferred service providers and a first layer of service modules, the server's providing a listed price by summarizing module prices that each of a predetermined number of providers provides in advance, that the server prepared in advance, so that the client compares the listed price;
selecting second layers of detailed service module of the corresponding layered service modules that are more detailed than the first layers by the client;
if the client communicates with the preferred service provider through a messenger and selects the second layers of service modules, the server's providing a adjusted price for each of the predetermined number of providers by summarizing modules and prices that the server prepared in advance;
the client and each of the one or more selected providers's discussing and agreeing on parameters (a variety of variables for the service task) for determining use of preset detailed coefficient values that the server uses to calculate, after the client meets the predetermined number of providers in a venue for providing the service and each of the predetermined number of providers selects the kinds of final work and memos in the database, so as to provide a quoted price of each of the predetermined number of providers to the client by adjusting the preset detailed coefficient values and making a decision; and
summarizing and showing a combination of the listed price, the adjusted price, and the quoted price along with the plurality of coefficient values and the detailed coefficient values of the predetermined number of providers in terms of table, graph, or chart by the server.

16. A company-grading method for O2O business model between a plurality of providers and a client in a computer network having a server and a plurality of terminals, the method comprising a step for determining the grading rate for one of the plurality of providers using a company information using an AI system, wherein the company profile comprises size of company, store interior design, number of employee, number of years with the O2O business model system, number of projects, year of establishment, the total sales, insurance, certificate, license, client reviews rate, number of reviewers, response time upon client's requests, response rate, activity rate on the O2O business model system, provider grade by O2O business model system, number of dissatisfaction received from clients, and number of breach of contract,
wherein the AI system generates the grade of the providers every quarter through an algorithm along with the response time data collected through the server, wherein the server collects data from the communication exchanged between providers and their potential clients, wherein this communication response time measures the time interval that occurs between the initial request sent by clients and the first response sent by the provider,
wherein the AI system analyzes and processes technical sentence and memo inputted to a provider's database for the unique estimate and invoice by the providers with a machine-learning technique, so as to calculate point values for company-grading, wherein the AI system measures frequency of using of technical sentences and gives points according to suitability and the frequency of the technical sentences, wherein the provider stores a plurality of unique technical sentences and expressions in the provider's database, so as to be used by the AI system in generating the grade,
wherein the AI system provides a plurality of environment coefficients for the adjusted price with the analyzing conditions or big data including various external factors obtained from Internet comprising season, peak time, schedule, time of the day, price of material, and weather,
wherein AI system uses different applications for different variables, elements, and contract terms, based on the service types, wherein the contract terms are selected so as to fit to corresponding service types and to be agreeable to the client and the provider.

17. The company-grading method for O2O business model of claim 16, wherein the AI system automatically generates a warning message to the O2O business model system, and the O2O business model system audits the provider to determine fraudulent activity if the provider's total sales increases unrealistically from the previous year compared to the average growth rate of the local market.

18. The O2O business model system of claim 16, wherein the AI system uses one of the data for generating the provider's grade generating that the provider stores the unique technical sentence and memo to a provider's database for the estimate and invoice quality, wherein each of the service providers stores proper technical sentences and memos related to the service, wherein the AI system learns sentences related to the service and grades the level of sentences that the service provider inputs, and measures quantity of technical sentences and memos and frequency of using the technical sentences and memos in the estimate that the service provider submits to the client.
